(19) United States
(12) Patent Application Publication
(10) Pub. No.: US 2017/0262578 A1
(43) Pub. Date: Sep. 14, 2017

(54) SYSTEM, METHOD AND SOFTWARE FOR ANALYSIS OF INTRACELLULAR SIGNALING PATHWAY ACTIVATION USING TRANSCRIPTOMIC DATA

(71) Applicant: PATHWAY PHARMACEUTICALS LTD, Wan Chai Hong Kong SAR (HK)

(72) Inventors: Anton BUZDIN, Istra Moscow region (RU); Nicolay BORISOV, Krasnoznamensk Moscow region (RU); Alexander ZHAVORONKOV, Moscow (RU)

(21) Appl. No.: 15/524,724

(22) PCT Filed: May 25, 2015
(86) PCT No.: PCT/IL2015/000029

§ 371 Date: May 5, 2017

(51) Int. Cl. G06F 19/12; G06F 19/20

(52) U.S. Cl. CPC G06F 19/12; G06F 19/20

(57) ABSTRACT

The present invention provides systems, methods and software for analysis of the intracellular signaling pathway activation (SPA), the method including analyzing activator and repressor roles of a plurality of gene products in a plurality of pathways in a sample of a subject to determine a pathway activation strength (PAS) for each of the plurality of pathways and comparing the pathway activation strength (PAS) in at least one sick subject with at least one healthy subject to determine intracellular signaling pathway activation (SPA) associated with a disease or disorder in the at least one sick subject.

### FIELD OF THE INVENTION

The present invention relates generally to systems and methods of analysis of transcriptomic data, and more specifically to systems and methods for intracellular signaling pathway activation using transcriptomic data.

### BACKGROUND OF THE INVENTION

In the twentieth century, enormous strides were made in combatting infectious diseases, in their detection and drugs to treat them. The major problem in the medical world has thus shifted from treating acute diseases to treating chronic diseases. Over the last few decades, with the advent of genetic engineering, much research and funding has been invested in genomics and gene-based personalized medicine. A need has arisen to develop diagnostic tools for use in the characterization of personalized aspects of chronic diseases.

Intracellular signaling pathways (SPs) regulate numerous processes involved in normal and pathological conditions including development, growth, aging and cancer. Many bioinformatic tools have been developed, which analyze SPs. Many intracellular signaling pathways or maps are available at online websites. Additionally, they can be found in publications, such as, but not limited to Cooper et al, 2000 and Krauss, 2008.

The information relating to signaling pathway activation (SPA) can be obtained from the massive proteomic or transcriptomic data. Although the proteomic level may be somewhat closer to the biological function of SPA, the transcriptomic level of studies today is far more feasible in terms of performing experimental tests and analyzing the data.

Intracellular signaling pathways (SPs) regulate numerous processes involved in normal and pathological conditions including development, growth, aging and cancer. Many bioinformatic tools have been developed recently that analize SPs. However, none of them makes it possible to efficiently do the high-throughput quantification of pathway activation scores for the individual biological samples. Here we propose a method for quick, informative and large-scale screening of changes in signaling pathway activation (SPA) in cells and tissues. These changes may reflect various differential conditions like differences in physiological state, aging, disease, treatment with drugs, infections, media composition, additives, etc. One of the potential applications of SPA studies may be in utilizing mathematical algorithms to identify and rank the medicines based on their predicted efficacy.

The information about SPA can be obtained from the massive proteomic or transcriptomic data. Although the proteomic level may be somewhat closer to the biological function of SPA, the transcriptomic level of studies today is far more feasible in terms of performing experimental tests and analizing the data. The transcriptomic methods like Next-generation sequencing (NGS) or microarray analysis of RNA can routinely determine expression levels for all or virtually all human genes (Shirane, 2004). Transcriptome profiling may be performed for the minute amount of the tissue sample, not necessarily fresh, but also for the clinical formalin-fixed, paraffin-embedded (FFPE) tissue blocks. For the molecular analysis of cancer, gene expression can be interpreted in terms of abnormal SPA features of various pro- and antimitotic signaling pathways. Such analysis may improve further decision-making process of treatment strategy selection by the clinician.

Pro- and antimitotic SPs that determine various stages of cell cycle progression remained in the spotlight of the computational biologists for more than a decade (Kholodenko, 1999; Borisov, 2009; Kuzmina, 2011). Today, hundreds of SPs and related gene product interaction maps that show sophisticated relationships between the individual molecules, are catalogued in various databases like UniProt (The UniProt consortium, 2011), HPRD (Mathivanan, 2006), QIAGEN SABiosciences (SABiosciences), WikiPathways (Bauer-Mehren, 2009), Ariadne Pathway Studio (Nikitin, 2004), SPIKE (Elkon, 2008), Reactome (Haw, 2012), KEGG (Nakaya, 2013), etc.

One group of bioinformatic approaches integrated the analysis of transcriptome-wide data with the models employing the mass action law and Michaelis-Meten kinetics (Yizhak, 2013). These methods which were developing during last fifteen years, however, remained purely fundamental until recently, primarily, because of the multiplicity of interaction domains in the signal transducer proteins that enormously increase the interactome complexity (Borisov, 2008; Conzelman, 2006). Secondly, a considerable number of unknown free parameters, such as kinetics constants and/or concentrations of protein molecules, significantly complicated the SPA analysis. Yizhak et al. (2013) suggested that the clinical efficiency of several drugs, e.g. geroprotectors, may be evaluated as the ability to induce the kinetic models of the pathways into the steady state. However, protein-protein interactions were quantitatively characterized in detail only for a tiny fraction of SPs. This approach is also time-consuming since to process each transcriptomic dataset it requires extensive calculations for the kinetic models (Yizhak, 2013).

However, all the contemporary bioinformatical methods that were proposed for digesting large-scale gene expression data followed by recognition and analysis of SPs, have an important disadvantage. They do not allow tracing the overall pathway activation signatures and quantitively estimate the extent of SPA (Hwang, 2012; Kuzmina, 2011; Yizhak, 2013). This may be due to lack of the definition of the specific roles of the individual gene products in the overall signal transduction process, incorporated in the calculation matrix used to estimate SPA.

US2008254497A provides a method of determining whether tumor cells or tissue is responsive to treatment with an ErbB pathway-specific drug. In accordance with the invention, measurements are made on such cells or tissues to determine values for total ErbB receptors of one or more types, ErbB receptor dimers of one or more types and their phosphorylation states, and/or one or more ErbB signaling pathway effector proteins and their phosphorylation states. These quantities, or a response index based on them, are positively or negatively correlated with cell or tissue responsiveness to treatment with an ErbB pathway-specific drug. In one aspect, such correlations are determined from a model of the mechanism of action of a ErbB pathway-specific drug on an ErbB pathway. Preferably, methods of the invention are implemented by using sets of binding compounds having releasable molecular tags that are specific for multiple components of one or more complexes formed in ErbB pathway activation. After binding, molecular tags are released and separated from the assay mixture for analysis.

U.S. Pat. No. 8,623,592 discloses methods for treating patients which methods comprise methods for predicting responses of cells, such as tumor cells, to treatment with therapeutic agents. These methods involve measuring, in a sample of the cells, levels of one or more components of a cellular network and then computing a Network Activation State (NAS) or a Network Inhibition State (NIS) for the cells using a computational model of the cellular network. The response of the cells to treatment is then predicted based on the NAS or NIS value that has been computed. The invention also comprises predictive methods for cellular responsiveness in which computation of a NAS or NIS value for the cells (e.g., tumor cells) is combined with use of a statistical classification algorithm. Biomarkers for predicting responsiveness to treatment with a therapeutic agent that targets a component within the ErbB signaling pathway are also provided.

There thus remains a need for systems and methods, which provide rapid personalized analyses of signaling pathway activation, based upon small tissue samples from an individual. These systems need to be applied to provide predictions of disease or disorder diagnosis and disease or disorder progress.

### SUMMARY OF THE INVENTION

It is an object of some aspects of the present invention to provide systems and methods, which provide rapid personalized analyses of signaling pathway activation, based upon small tissue samples from an individual.

In other embodiments of the present invention, a method and system is described for providing personalized analyses of optimized drug profiles in accordance with a patient genetic profile.

In additional embodiments for the present invention, a method and system for predicting optimized drug profiles for treating a specific patient disease or disorder are provided.

In further embodiments of the present invention, a method and system for predicting optimized drug profiles for treating a specific patient proliferative disease or disorder are provided.

It is an object of some aspects of the present invention, to provide a proliferative transcriptome in which the transcribed genes in subjects with a proliferative disease or disorder relative (sick subjects) to healthy individuals are compared to define a set first of genes which are more strongly expressed (activated) in sick people or subjects relative to healthy people or subjects and a second set of genes (repressed) which are less strongly expressed in sick people or subjects relative to healthy people or subjects.

In some embodiments of the present invention, improved methods and software are provided for determining a pathway activation strength in sick subjects relative to healthy subjects of the same species. In some embodiments, the species is a vertebrate species. In some embodiments, the species is a mammalian species. In some preferred embodiments, the subject is a human species.

The generic cancer-protector rating approach involves collecting the transcriptome datasets from sick and healthy patients and normalizing the data for each cell and tissue type, evaluating the pathway activation strength (PAS) for each individual pathway and constructing the pathway cloud and screen for drugs or combinations that minimize the signaling pathway cloud disturbance by acting on one or multiple elements of the pathway cloud. Drugs and combinations may be rated by their ability to return the signaling pathway activation pattern closer to that of the healthier tissue samples. The predictions may be then tested both in vitro and in vivo on human cells and on model organisms such as rodents, nematodes and flies to validate the screening and rating algorithms.

The present invention provides a method for ranking cancer-protective/treatment drugs, the method including collecting healthy subject transcriptome data and sick subject transcriptome data for one species to evaluate pathway activation strength (PAS) and downregulation strength for a plurality of biological pathways, mapping the plurality of biological pathways for the activation strength and downregulation strength from sick subject samples relative to helathy subject samples to form a pathway cloud map and providing a cancer-protective rating for each of a plurality of drugs in accordance with a drug rating for minimizing signaling pathway cloud disturbance (SPCD) in the pathway cloud map of the one species to provide a ranking of the cancer-protective drugs.

There is thus provided according to an embodiment of the present invention, a method for analysis of the intracellular signaling pathway activation (SPA), the method including;
a. analyzing activator and repressor roles of a plurality of gene products in a plurality of pathways in at least one sample of at least one healthy subject and at least one sick subject to determine a pathway activation strength (PAS) for each of the plurality of pathways; and
b. comparing the pathway activation strength (PAS) in the at least one sick subject with the at least one healthy subject to determine intracellular signaling pathway activation (SPA) associated with a disease or disorder in the at least one sick subject.

Additionally, according to an embodiment of the present invention, the method is quantitative.

Further, according to an embodiment of the present invention, the method is qualitative.

Yet further, according to an embodiment of the present invention, the subject is a vertebrate.

Moreover, according to an embodiment of the present invention, the subject is mammalian.

Additionally, according to an embodiment of the present invention, the subject is human.

Furthermore, according to an embodiment of the present invention, the sick subject suffers from a proliferative disease or disorder.

In some cases, according to an embodiment of the present invention, the proliferative disease or disorder is cancer.

Importantly, according to an embodiment of the present invention, the PAS is defined by

$${PAS}_{p} = {\sum }_{n} {ARR}_{np} \cdot lg ( {CNR}_{n} ) .$$

Additionally importantly, according to an embodiment of the present invention, the SPA is defined by

$${PAS}_{p}^{( 1 , 2 )} = {\sum }_{n} {ARR}_{np} \cdot {BTIF}_{n} \cdot {w}_{n}^{( 1 , 2 )} \cdot lg ( {CNR}_{n} ) .$$

There is thus provided according to another embodiment of the present invention, a computer software product, the product configured for analysis of the intracellular signaling pathway activation (SPA), the product including a computer-readable medium in which program instructions are stored, which instructions, when read by a computer, cause the computer to;
a. analyze activator and repressor roles of a plurality of gene products in a plurality of pathways in at least one sample of at least one healthy subject and at least one sick subject to determine a pathway activation strength (PAS) for each of the plurality of pathways; and
b. compare the pathway activation strength (PAS) in the at least one sick subject with the at least one healthy subject to determine intracellular signaling pathway activation (SPA) associated with a disease or disorder in the at least one sick subject.

There is thus provided according to yet another embodiment of the present invention, a system for analysis of the intracellular signaling pathway activation (SPA), the system including;
a. a processor adapted to activate a computer-readable medium in which program instructions are stored, which instructions, when read by a computer, cause the processor to;
   i. analyze activator and repressor roles of a plurality of gene products in a plurality of pathways in at least one sample of at least one healthy subject and at least one sick subject to determine a pathway activation strength (PAS) for each of the plurality of pathways; and
   ii. compare the pathway activation strength (PAS) in the at least one sick subject with the at least one healthy subject to determine intracellular signaling pathway activation (SPA) associated with a disease or disorder in the at least one sick subject.
b. a memory for storing the pathway activation strength (PAS) for each of the plurality of pathway and intracellular signaling pathway activation (SPA) associated with a disease or disorder; and
c. a display for displaying data associated with the at least one sick subject.

There is thus provided according to a further embodiment of the present invention, a bioinformatics method for ranking onco-protective drugs, the method including;
a. collecting healthy subject transcriptome data and sick subject transcriptome data for one species to evaluate pathway activation strength (PAS) and downregulation strength for a plurality of biological pathways;
b. mapping the plurality of biological pathways for the activation strength and downregulation strength from sick subject samples relative to healthy subject samples to form a pathway cloud map; and
c. providing a disease-protective rating for each of a plurality of drugs in accordance with a drug rating for minimizing signaling pathway cloud disturbance (SPCD) in the pathway cloud map of the one species to provide a ranking of the onco-protective drugs.

Further, according to an embodiment of the present invention, n the pathway cloud map shows at least one upregulated/activated pathway and at least one downregulated pathway of the sick subject relative to the healthy subject.

Yet further, according to an embodiment of the present invention, the pathway cloud map is based on a plurality of healthy subjects and a plurality of sick subjects.

Additionally, according to an embodiment of the present invention, the method is performed on a plurality of ethnic groups to determine an optimized ranking of the disease-protective drugs for each ethnic group.

Furthermore, according to an embodiment of the present invention, the method is performed for an individual to determine an optimized ranking of the disease-protective drugs for the individual.

Further, according to an embodiment of the present invention, the mapping step further includes mapping each of the plurality of biological pathways for the activation strength and the down-regulation strength.

Furthermore, according to an embodiment of the present invention, the biological pathways are signaling pathways.

Additionally, according to an embodiment of the present invention data is obtained from studies on the samples of the subjects.

Further, according to an embodiment of the present invention, the samples are bodily samples selected from the group consisting of a blood sample, a urine sample, a biopsy, a hair sample, a nail sample, a breathe sample, a saliva sample and a skin sample.

Moreover, according to an embodiment of the present invention, the pathway activation strength is calculated by dividing the expression levels for a gene n in the sick subject samples by the gene expression levels of the healthy subject samples.

Further, according to an embodiment of the present invention, the pathway activation strength is calculated by the formula,

$${PAS}_{p} = {\sum }_{n} {ARR}_{np} \cdot lg ( {CNR}_{n} ) .$$

Yet further, according to an embodiment of the present invention, the SPA is defined by

$${PAS}_{p}^{( 1 , 2 )} = {\sum }_{n} {ARR}_{np} \cdot {BTIF}_{n} \cdot {w}_{n}^{( 1 , 2 )} \cdot lg ( {CNR}_{n} ) .$$

There is thus provided according to an additional embodiment of the present invention, a bioinformatics computer software product, the product configured for ranking onco-protective drugs, the product including a computer-readable medium in which program instructions are stored, which instructions, when read by a computer, cause the computer to;
a. collect healthy subject transcriptome data and sick subject transcriptome data for one species to evaluate pathway activation strength (PAS) and downregulation strength for a plurality of biological pathways;
b. map the plurality of biological pathways for the activation strength and downregulation strength from sick subject samples relative to healthy subject samples to form a pathway cloud map; and
c. provide a disease-protective rating for each of a plurality of drugs in accordance with a drug rating for minimizing signaling pathway cloud disturbance (SPCD) in the pathway cloud map of the one species to provide a ranking of the onco-protective drugs.

There is thus provided according to a further embodiment of the present invention, a bioinformatics system for ranking onco-protective drugs, the system including;
a. a processor adapted to activate a computer-readable medium in which program instructions are stored, which instructions, when read by a computer, cause the processor to;
   i. collect healthy subject transcriptome data and sick subject transcriptome data for one species to evaluate pathway activation strength (PAS) and down-regulation strength for a plurality of biological pathways;
   ii. map the plurality of biological pathways for the activation strength and down-regulation strength from sick subject samples relative to healthy subject samples to form a pathway cloud map; and
   iii. provide an onco-protective rating for each of a plurality of drugs in accordance with a drug rating for minimizing signaling pathway cloud disturbance (SPCD) in the pathway cloud map of the one species to provide a ranking of the onco-protective drugs; and
b. a memory for storing the data, the pathway cloud map, SPCD and the ranking; and
c. a display for displaying the pathway cloud map.

Further, according to an embodiment of the present invention, the display is adapted to show the ranking by at least one of color, line thickness and visual indicia.

There is thus provided according to another embodiment of the present invention, a method for treating a sick subject with a disease or disorder, the method including;
a. ranking onco-protective drugs by:—
   i. collecting healthy subject transcriptome data and sick subject transcriptome data for one species to evaluate pathway activation strength (PAS) and downregulation strength for a plurality of biological pathways;
   ii. mapping the plurality of biological pathways for the activation strength and downregulation strength from sick subject samples relative to healthy subject samples to form a pathway cloud map; and
   iii. providing a disease-protective rating for each of a plurality of drugs in accordance with a drug rating for minimizing signaling pathway cloud disturbance (SPCD) in the pathway cloud map of the one species to provide a ranking of the onco-protective drugs to define a personalized ranking of onco-protective drugs; and
b. treating the sick subject in accordance with the personalized ranking of onco-protective drugs to treat the sick subject.

Further, according to an embodiment of the present invention, the disorder is a proliferative disorder.

Additionally, according to an embodiment of the present invention, the proliferative disorder is cancer.

Importantly, according to an embodiment of the present invention, wherein the method is effective in slowing down the cancer.

Additionally importantly, according to an embodiment of the present invention, the method is effective in curing the cancer.

There is thus provided according to another embodiment of the present invention, a bioinformatics computer software product, the product configured for providing an optimized treatment regimen for a sick subject, the product including a computer-readable medium in which program instructions are stored, which instructions, when read by a computer, cause the computer to;
a. collect healthy subject transcriptome data and sick subject transcriptome data for one species to evaluate pathway activation strength (PAS) and downregulation strength for a plurality of biological pathways;
b. map the plurality of biological pathways for the activation strength and downregulation strength from sick subject samples relative to healthy subject samples to form a pathway cloud map;
c. provide a disease-protective rating for each of a plurality of drugs in accordance with a drug rating for minimizing signaling pathway cloud disturbance (SPCD) in the pathway cloud map of the one species to provide a ranking of the onco-protective drugs; and
d. output a personalized treatment regimen in accordance with the ranking of the onco-protective drugs.

There is thus provided according to another embodiment of the present invention, a method for treating a sick subject with a disease or disorder, the method including;
a. collecting healthy subject transcriptome data and sick subject transcriptome data for one species to evaluate pathway activation strength (PAS) and downregulation strength for a plurality of biological pathways;
b. mapping the plurality of biological pathways for the activation strength and downregulation strength from sick subject samples relative to healthy subject samples to form a pathway cloud map;
c. providing a disease-protective rating for each of a plurality of drugs in accordance with a drug rating for minimizing signaling pathway cloud disturbance (SPCD) in the pathway cloud map of the one species to provide a ranking of the onco-protective drugs; and
d. treating the sick subject in accordance with the personalized ranking of onco-protective drugs to treat the sick subject.

There is thus provided according to another embodiment of the present invention, a bioinformatics computer software product, the product configured for providing an optimized treatment regimen for a sick subject, the product including a computer-readable medium in which program instructions are stored, which instructions, when read by a computer, cause the computer to;
a. collect healthy subject transcriptome data and sick subject transcriptome data for one species to evaluate pathway activation strength (PAS) and downregulation strength for a plurality of biological pathways;
b. map the plurality of biological pathways for the activation strength and downregulation strength from sick subject samples relative to healthy subject samples to form a pathway cloud map;
c. provide a disease-protective rating for each of a plurality of drugs in accordance with a drug rating for minimizing signaling pathway cloud disturbance (SPCD) in the pathway cloud map of the one species to provide a ranking of the onco-protective drugs; and
d. output a personalized treatment regimen in accordance with the ranking of the onco-protective drugs and personalized data pertaining to the sick subject.

There is thus provided according to another embodiment of the present invention, a bioinformatics system for treating a sick subject, the system including;
a. a processor adapted to activate a computer-readable medium in which program instructions are stored, which instructions, when read by a computer, cause the processor to;
   i. collect healthy subject transcriptome data and sick subject transcriptome data for one species to evaluate pathway activation strength (PAS) and downregulation strength for a plurality of biological pathways;
   ii. map the plurality of biological pathways for the activation strength and downregulation strength from sick subject samples relative to healthy subject samples to form a pathway cloud map;
   iii. provide a disease-protective rating for each of a plurality of drugs in accordance with a drug rating for minimizing signaling pathway cloud disturbance (SPCD) in the pathway cloud map of the one species to provide a ranking of the onco-protective drugs; and
   iv. output a personalized treatment regimen in accordance with the ranking of the onco-protective drugs and personalized data pertaining to the sick subject.
b. a memory for storing at least some of the data, the pathway cloud map, the SPCD, the ranking and the personalized treatment regimen; and
c. a display for displaying at least one of the data, the pathway cloud map, the SPCD, the ranking and the personalized treatment regimen.

A bioinformatics method for predicting efficacy of a drug in treating a disease or disorder, the method including;
a. collecting healthy subject transcriptome data and sick subject transcriptome data for one species to evaluate pathway activation strength (PAS) and downregulation strength for a plurality of biological pathways;
b. mapping the plurality of biological pathways for the activation strength and downregulation strength from sick subject samples relative to healthy subject samples to form a pathway cloud map; and
c. generating a predicted efficacy of a drug for at least one of the disease or the disorder based upon minimizing a signaling pathway cloud disturbance (SPCD) in the pathway cloud map.

There is thus provided according to another embodiment of the present invention, a bioinformatics computer software product, the product configured for predicting efficacy of a drug in treating a disease or disorder, the product including a computer-readable medium in which program instructions are stored, which instructions, when read by a computer, cause the computer to;
a. collect healthy subject transcriptome data and sick subject transcriptome data for one species to evaluate pathway activation strength (PAS) and downregulation strength for a plurality of biological pathways;
b. map the plurality of biological pathways for the activation strength and downregulation strength from sick subject samples relative to healthy subject samples to form a pathway cloud map; and
c. generating a predicted efficacy of a drug for at least one of the disease or the disorder based upon minimizing a signaling pathway cloud disturbance (SPCD) in the pathway cloud map for at least one of the disease or the disorder.

There is thus provided according to another embodiment of the present invention, a bioinformatics system for predicting efficacy of a drug in treating a disease or a disorder, the system including;
a. a processor adapted to activate a computer-readable medium in which program instructions are stored, which instructions, when read by a computer, cause the processor to;
   i. collect healthy subject transcriptome data and sick subject transcriptome data for one species to evaluate pathway activation strength (PAS) and downregulation strength for a plurality of biological pathways;
   ii. map the plurality of biological pathways for the activation strength and downregulation strength from sick subject samples relative to healthy subject samples to form a pathway cloud map; and
   iii. generate a predicted efficacy of a drug for at least one of the disease or the disorder based upon minimizing a signaling pathway cloud disturbance (SPCD) in the pathway cloud map for at least one of the disease or the disorder;
b. a memory for storing at least some of the data, the pathway cloud map, the SPCD, the predicted efficacy; and
c. a display for displaying at least one of the data, the pathway cloud map, the SPCD, the predicted efficacy.

There is thus provided according to another embodiment of the present invention, a bioinformatics in silico method for ranking predicted drug efficacy for treating a disease or a disorder, the method including;
a. collecting healthy subject transcriptome data and sick subject transcriptome data for one species to evaluate pathway activation strength (PAS) and downregulation strength for a plurality of biological pathways;
b. mapping the plurality of biological pathways for the activation strength and downregulation strength from sick subject samples relative to healthy subject samples to form a pathway cloud map; and
c. providing a disease-protective rating for each of a plurality of drugs in accordance with a drug rating for minimizing signaling pathway cloud disturbance (SPCD) in the pathway cloud map of the one species to provide a ranking of the predicted drug efficacy for each of the plurality of drugs.

There is thus provided according to another embodiment of the present invention, a bioinformatics computer software product, the product configured for ranking predicted drug efficacy for treating a disease or a disorder, the product including a computer-readable medium in which program instructions are stored, which instructions, when read by a computer, cause the computer to;
a. collect healthy subject transcriptome data and sick subject transcriptome data for one species to evaluate pathway activation strength (PAS) and downregulation strength for a plurality of biological pathways;
b. map the plurality of biological pathways for the activation strength and downregulation strength from sick subject samples relative to healthy subject samples to form a pathway cloud map; and
c. provide a disease-protective rating for each of a plurality of drugs in accordance with a drug rating for minimizing signaling pathway cloud disturbance (SPCD) in the pathway cloud map of the one species to provide a ranking of the predicted drug efficacy for each of the plurality of drugs.

There is thus provided according to another embodiment of the present invention, a bioinformatics system for ranking onco-protective drugs, the system including;
a. a processor adapted to activate a computer-readable medium in which program instructions are stored, which instructions, when read by a computer, cause the processor to;
   i. collect healthy subject transcriptome data and sick subject transcriptome data for one species to evaluate pathway activation strength (PAS) and downregulation strength for a plurality of biological pathways;
   ii. map the plurality of biological pathways for the activation strength and downregulation strength from sick subject samples relative to healthy subject samples to form a pathway cloud map; and
   iii. provide a disease-protective rating for each of a plurality of drugs in accordance with a drug rating for minimizing signaling pathway cloud disturbance (SPCD) in the pathway cloud map of the one species to provide a ranking of the predicted drug efficacy for each of the plurality of drugs; and
b. a memory for storing the data, the pathway cloud map, SPCD and the ranking.

Further, according to an embodiment of the present invention, the system further includes a display for displaying the pathway cloud map.

Yet further, according to an embodiment of the present invention, the display is adapted to show the ranking by at least one of color, line thickness and visual indicia.

There is thus provided according to another embodiment of the present invention, a bioinformatics in silico method for prediction of the drug efficacy for treating a disease or a disorder of an individual patient, the method including;
a. collecting healthy subject transcriptome data and sick subject transcriptome data for one species to evaluate differential gene expression, pathway activation strength (PAS) and downregulation strength for a plurality of biological pathways;
b. calculating the predicted efficiency scores (drug score, DS) for the individual drugs basing on the analysis of the transcriptomes, including PAS data, according to point (a)
c. providing a disease-protective rating for each of a plurality of drugs in accordance with a drug score (DS) list for efficiently blocking physiological process(es) leading to disease to provide a ranking of the predicted drug efficacy for each of the plurality of drugs.

Additionally, according to an embodiment of the present invention, the drug score is calculated by the formula

$$DS {1}_{d} = {\sum }_{t} {DTI}_{dt} {\sum }_{p} {NII}_{tp} \cdot {PAS}_{p} ,$$

and wherein d is a drug number, t is a number of target protein, and p is a signaling pathway number.

Yet further, according to an embodiment of the present invention, the PAS is defined by

$${PAS}_{p}^{( 1 , 2 )} = {\sum }_{n} {ARR}_{np} \cdot {BTIF}_{n} \cdot {w}_{n}^{( 1 , 2 )} \cdot lg ( {CNR}_{n} ) .$$

There is thus provided according to another embodiment of the present invention, a bioinformatics system for operating with drug scores, the system including a processor adapted to activate a computer-readable medium in which program instructions are stored, which instructions, when read by a computer, cause the processor to calculate a drug score according to the formula

$$DS {1}_{d} = {\sum }_{t} {DTI}_{dt} {\sum }_{p} {NII}_{tp} \cdot {PAS}_{p} ,$$

and wherein d is a drug number, t is a number of target protein, and p is a signaling pathway number.

Additionally, according to an embodiment of the present invention, the PAS is defined by

$${PAS}_{p}^{( 1 , 2 )} = {\sum }_{n} {ARR}_{np} \cdot {BTIF}_{n} \cdot {w}_{n}^{( 1 , 2 )} \cdot lg ( {CNR}_{n} ) .$$

There is thus provided according to another embodiment of the present invention, bioinformatic software for operating with drug scores the product configured for ranking predicted drug efficacy for treating a disease or a disorder, the product including a computer-readable medium in which program instructions are stored, which instructions, when read by a computer, cause the computer to;
a. collect healthy subject transcriptome data and sick subject transcriptome data for one species to evaluate differential gene expression, pathway activation strength (PAS) and downregulation strength for a plurality of biological pathways;
b. calculate the predicted efficiency scores (drug score, DS) for the individual drugs basing on the analysis of the transcriptomes, including PAS data, according to point (a);
c. provide a disease-protective rating for each of a plurality of drugs in accordance with a drug score (DS) list for efficiently blocking physiological process(es) leading to disease to provide a ranking of the predicted drug efficacy for each of the plurality of drugs; and
d. calculating the drug score according to the formula

$$DS {1}_{d} = {\sum }_{t} {DTI}_{dt} {\sum }_{p} {NII}_{tp} \cdot {PAS}_{p} ,$$

and wherein d is a drug number, t is a number of target protein, and p is a signaling pathway number.

The present invention will be more fully understood from the following detailed description of the preferred embodiments thereof, taken together with the drawings and appendices.

### BRIEF DESCRIPTION OF THE DRAWINGS

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified schematic illustration of a system for analysis of intracellular signaling pathway activation using transcriptomic data, in accordance with an embodiment of the present invention;

FIG. 2 is a simplified schematic illustration of values of pathway activation strength that were calculated, each having random log-normally distributed weighting factors wn (Perturbed PMS in the figure), versus non-perturbed PAS for the different SPs, calculated using OncoFinder method (Unperturbed PMS on the figure), in accordance with an embodiment of the present invention;

FIG. 3 is a simplified flow chart of a method for analysis of intracellular signaling pathway activation using transcriptomic data, in accordance with an embodiment of the present invention;

FIG. 4A is a simplified schematic illustration displaying samples of most and least altered pathways, compared with the normal signaling pathways, Green arrows—increasingly activated pathways, red arrows—insufficiently activated. Ten arrows in the upper part of the figure (top to bottom); and

FIG. 4B is a simplified schematic illustration displaying samples of the ten most contributing to mitogenesis signaling pathways, ten arrows in the lower part of the figure (bottom-up)—the ten most hindering to mitogenesis signaling pathways, in accordance with an embodiment of the present invention.

### DETAILED DESCRIPTION OF THE EMBODIMENTS

In the detailed description, numerous specific details are set forth in order to provide a thorough understanding of the invention. However, it will be understood by those skilled in the art that these are specific embodiments and that the present invention may be practiced also in different ways that embody the characterizing features of the invention as described and claimed herein.

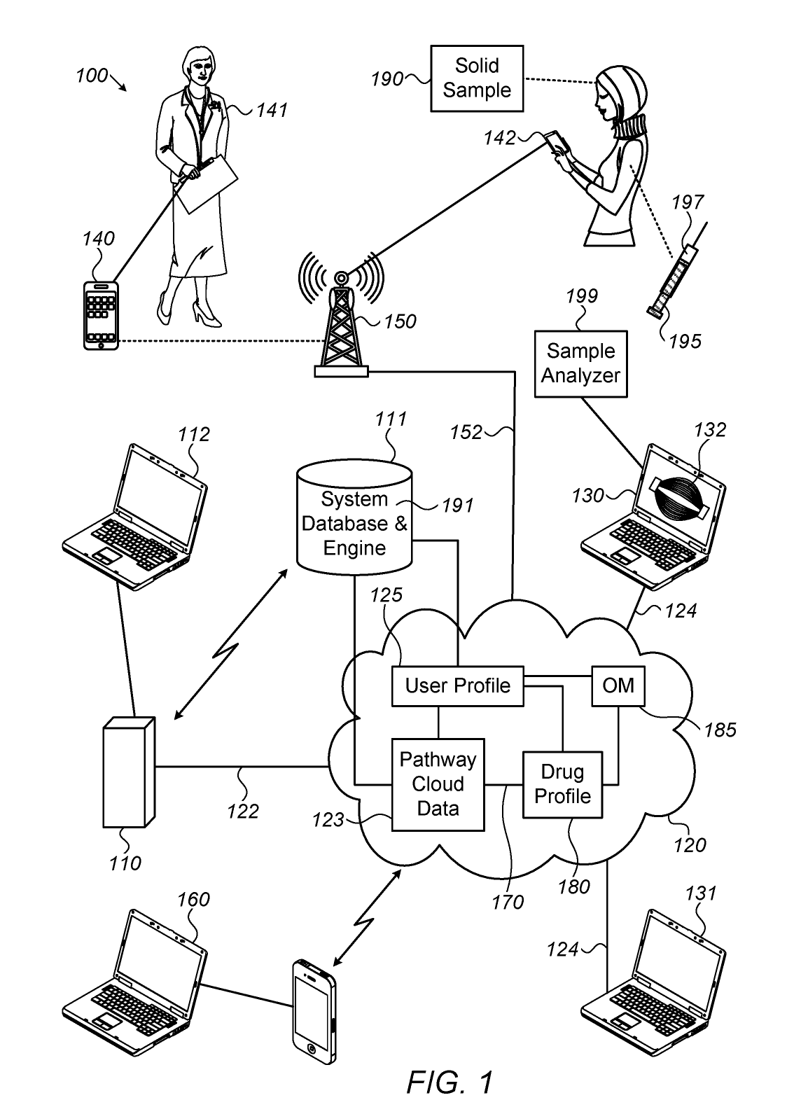

Reference is now made to FIG. 1, which is a simplified schematic illustration of a system for analysis of intracellular signaling pathway activation using transcriptomic data, in accordance with an embodiment of the present invention.

System 100 typically includes a server utility 110, which may include one or a plurality of servers and one or more control computer terminals 112 for programming, trouble-shooting servicing and other functions. Server utility 110 includes a system engine 111 and database, 191. Database 191 comprises a user profile database 125, a pathway cloud database 123 and a drug profile database 180.

Depending on the capabilities of a mobile device, system 100 may also be incorporated on a mobile device that synchronizes data with a cloud-based platform.

The drug profile database comprises data relating to a large number of drugs for controlling and treating cancer. For each type of drug, the dosage values, pharmo-kinetic data and profile, pharmodynamic data and profiles are included.

The drug profile database further comprises data of drug combinations, including dosage values pharmo-kinetic data and profile, pharmodynamic data and profiles.

A medical professional, research personnel or patient assistant/helper/carer 141 is connected via his/her mobile device 140 to server utility 110. The patient, subject or child 143 is also connected via his/her mobile device 142 to server utility 110. In some cases, the subject may be a mammalian subject, such as a mouse, rat, hamster, monkey, cat or dog, used in research and development. In other cases, the subject may be a vertebrate subject, such as a frog, fish or lizard. The patient or child is monitored using a sample analyzer 199. Sample analyzer 199, may be associated with one or more computers 130 and with server utility 110. Computer 130 and/or sample analyzer 199 may have software therein for performing the “oncofinder method” of the present invention. The outputs of the software may be displayed, such as a cloud map 132, described in further detail hereinbelow and in the appendices.

Typically, pathway cloud data 123 (FIG. 1), generated by the software of the present invention, is stored locally and/or in cloud 120 and/or on server 110.

The sample analyzer may be constructed and configured to receive a solid sample 190, such as a biopsy, a hair sample or other solid sample from patient 143, and/or a liquid sample 195, such as, but not limited to, urine, blood or saliva sample. The sample may be extracted by any suitable means, such as by a syringe 197.

The patient, subject or child 143 may be provided with a drug (not shown) by health professional/research/doctor 141.

System 100 further comprises an outputting module 185 for outputting data from the database via tweets, emails, voicemails and computer-generated spoken messages to the user, carers or doctors, via the Internet 120 (constituting a computer network), SMS, Instant Messaging, Fax through link 122.

Users, patients, health care professionals or customers 141, 143 may communicate with server 110 through a plurality of user computers 130, 131, or user devices 140, 142, which may be mainframe computers with terminals that permit individual to access a network, personal computers, portable computers, small hand-held computers and other, that are linked to the Internet 120 through a plurality of links 124. The Internet link of each of computers 130, 131, may be direct through a landline or a wireless line, or may be indirect, for example through an intranet that is linked through an appropriate server to the Internet. System 100 may also operate through communication protocols between computers over the Internet which technique is known to a person versed in the art and will not be elaborated herein.

Users may also communicate with the system through portable communication devices such as mobile phones 140, communicating with the Internet through a corresponding communication system (e.g. cellular system) 150 connectable to the Internet through link 152. As will readily be appreciated, this is a very simplified description, although the details should be clear to the artisan. Also, it should be noted that the invention is not limited to the user-associated communication devices—computers and portable and mobile communication devices—and a variety of others such as an interactive television system may also be used.

The system 100 also typically includes at least one call and/or user support and/or tele-health center 160. The service center typically provides both on-line and off-line services to users. The server system 110 is configured according to the invention to carry out the methods of the present invention described herein.

It should be understood that many variations to system 100 are envisaged, and this embodiment should not be construed as limiting. For example, a facsimile system or a phone device (wired telephone or mobile phone) may be designed to be connectable to a computer network (e.g. the Internet). Interactive televisions may be used for inputting and receiving data from the Internet. Future devices for communications via new communication networks are also deemed to be part of system 100. Memories may be on a physical server and/or in a virtual cloud.

A mobile computing device may also embody a non-synced or offline copy of memories, copies of pathway cloud data, user profiles database, drug profiles database and execute the system, engine locally.

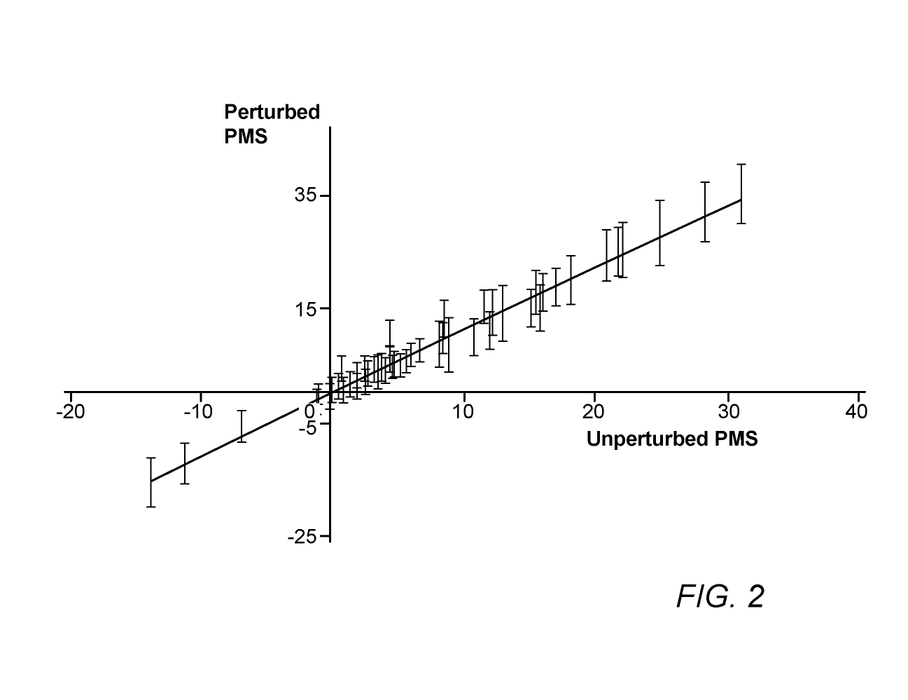

Reference is now made to FIG. 2, which provides values of pathway activation strength, in accordance with an embodiment of the present invention. The values of pathway activation were calculated using the 98 random trials, each having random log-normally distributed weighting factors wn (Perturbed PMS on the figure), versus non-perturbed PAS for the different SPs, calculated using OncoFinder method (Unperturbed PMS on the figure). The pathway information was extracted from the SABiosciences database. Primary data are shown on the Supplementary dataset 3. For the perturbed values (APAS), both average values (points at the plot) and standard deviation bars are shown.

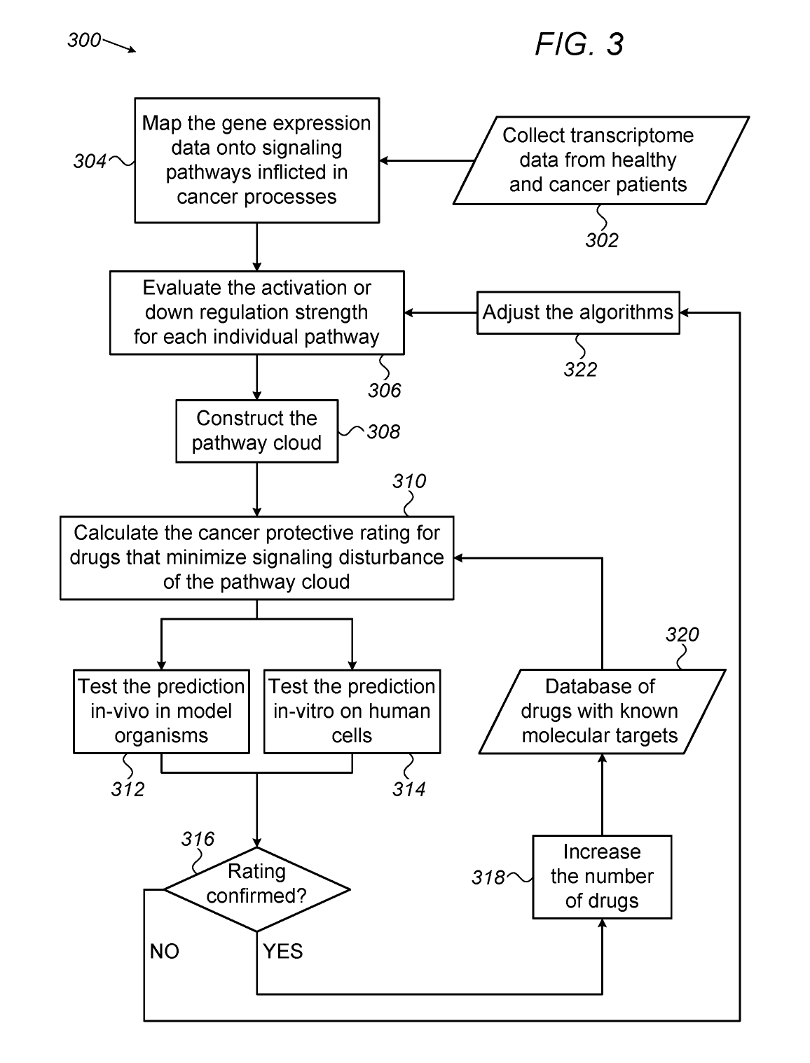

Reference is now made to FIG. 3, which is a simplified flow chart 300 of a method for analysis of intracellular signaling pathway activation using transcriptomic data, in accordance with an embodiment of the present invention.

In a first collecting step 302, transcriptome data from healthy and sick patients is collected and stored in a suitable database.

In a mapping step 304, the gene expression data collected in step 302 is mapped onto signaling pathways, which are affected by cancer processes.

In an evaluating step 306, the activation or down-regulation strength for each individual pathway is defined, providing one line per pathway.

Thereafter, in a cloud construction step 308, a cloud for sick versus healthy and/or healthy versus sick is constructed.

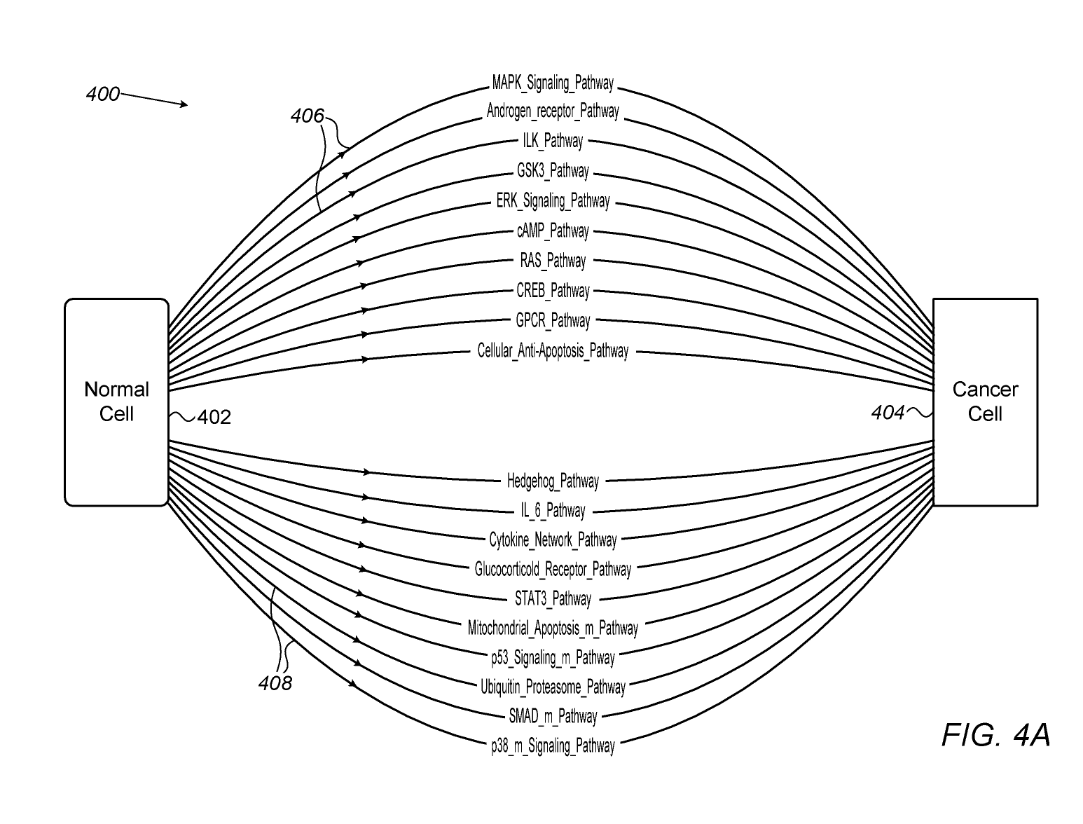

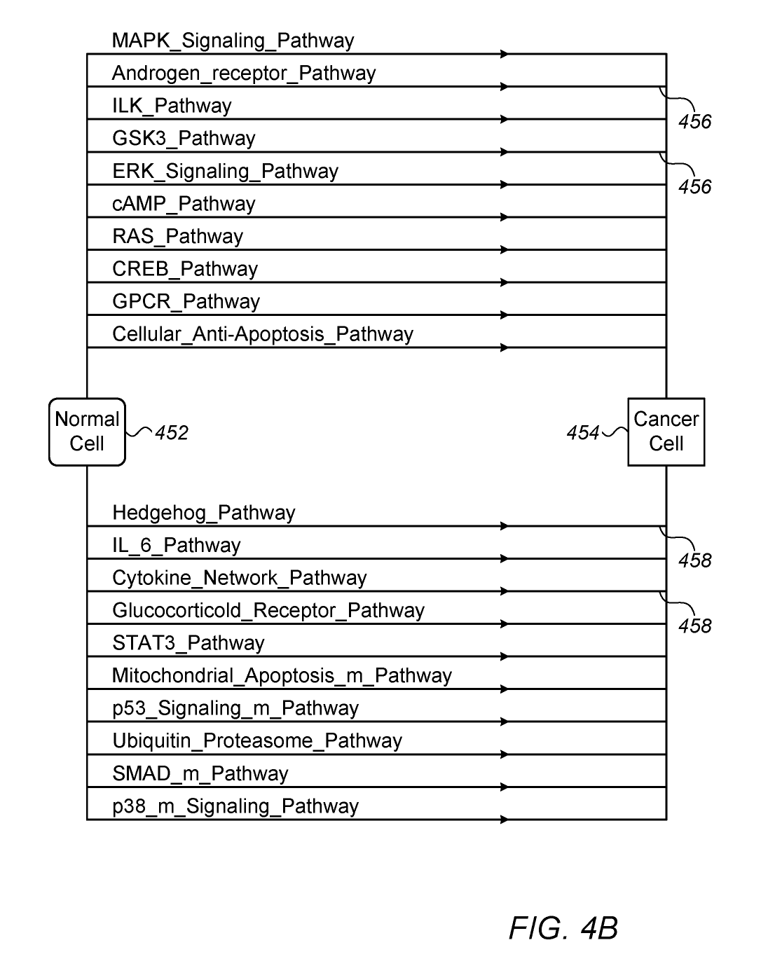

The lines are curved as upper halves of circles/ellipses and marked in green, for example, to denote up-regulation. Down-regulated pathways are lines curved as lower halves of circles/ellipses and marked in red, for example. Thus sets of upregulated and down-regulated paths are seen in 132, FIG. 1 and in further detail in FIGS. 4A-4B, hereinbelow.

Thereafter for a number of drugs, the onco-protective rating of each drug which minimizes the signaling disturbance of the pathway cloud is determined in a gero-protective rating calculation step 310.

In one or more testing steps, 312, 314, the prediction of step 310 is tested in vivo in laboratory animals and in human species, respectively. The outputs of steps 312, 314 are testing data confirming the ratings of step 310.

A checking step 316 is performed to compare the ratings of step 310 to actual testing data.

If the testing data confirms the rating of step 310, a new drug is added to in an adding drug step 318. The data associated with the new drug is added to a database of drugs with known molecular targets in adding new drug step 318. Its potency to provide cancer treatment and/or onco-protection is calculated in step 310 and it is then tested in steps 312-314. Step 314 is repeated and then, according to its results, steps 316-318 or 320, 306-314 again.

If the testing data does not match the predicted rating from step 310, the algorithm is adjusted in adjusting step 322 and steps 306-314 are repeated for that drug.

Using the methodology of the present invention, one or more drugs can be defined that provide the best predicted outcomes for a certain patient, based on his/her phenotypic profile.

Moreover, using the methodology of the present invention, one or more drugs can be defined that provide the best predicted outcomes for a group of patients suffering from the same disease.

Additionally, the methods of the present invention may allow the use of one or more drugs, which provide the best predicted outcomes for a group of patients of the same ethnicity, suffering from the same disease.

Reference is now made to FIG. 4A, which is a simplified schematic illustration 400 displaying samples of most and least activated pathways, 406, 408 compared with the normal signaling pathways (not shown), in accordance with an embodiment of the present invention. These pathways are illustrated as going from a normal cell 402 to a cancer cell 404. For example the ten most activated pathways 406 are shown in the upper part of the figure and the ten most hindered/inhibited/deactivated pathways 408 are shown in the lower part of the figure.

FIG. 4B is a simplified schematic illustration 450 displaying samples of the ten pathways 456 most contributing to mitogenesis signaling pathways, ten arrows in the lower part of the figure (bottom-up) 458 the ten most hindering to mitogenesis signaling pathways, in accordance with an embodiment of the present invention. In some cases the pathway way be blocked 459 (oblong) or not seen at all. Arrows 461 are symbolic of the pathway being active.

1. General Terms

The “OncoFinder system” described herein, is designed to advise oncologists conducting treatment of patients with malignant tumors. This computer system is a knowledge base that is used to support decisions regarding treatment of individual cancer patients by targeted anticancer drugs—monoclonal antibodies (mabs), kinase inhibitors (nibs), some hormones and stimulants. OncoFinder knowledgebase operates basic data, which are the results of microarray analysis of the transcriptome cell biopsy as malignant tumors and healthy tissue of similar organs. Result of the system is evaluation of the degree of pathological changes in the pro- and anti-mitotic signaling pathways and the ability of targeted anticancer drugs to compensate for these changes. This information can be used to forecast the clinical efficacy of drugs for individual patients with cancer and hematologic lesion. The Oncofinder system's knowledgebase based on database of targeted anticancer drugs and pro- and anti-mitotic signaling pathways, which contains information about the interaction of proteins and their corresponding genes. The system is implemented in the form of a cloud on-line software on “Amazon” web platform at http://aws.amazon.com/.

2. Targeted Anticancer Drugs and Problems of their Prescription

Among the drugs affecting mitogenesis targeted therapies for the treatment of cancer got widespread in clinical practice. Monoclonal antibodies (mabs) and kinase inhibitors (nibs) are widely used as such therapies. Monoclonal antibodies are an antibodies produced by the immune cells belonging to a single cell clone that has occurred from a single plasma progenitor cell. In medicine mabs used to destroy the malignant tumor cells and prevent its growth by blocking certain receptors and/or effectors. Mabs bind only to certain cancer cell antigens and induce an immunological response against it. Kinase inhibitors are also used to treat malignant neoplasms. They are not produced by cells of the immune system. The mechanism of their therapeutic action is inhibition of the kinase's activity.

Targets of targeted drugs are proteins that contribute to the malignant cells transformations, such as blocking apoptotic pathway, autocrine or conformational ensuring constitutive activation of signals initiated growth factor receptor, increased expression of vascular growth factor receptor causing increased angiogenesis in the marginal area of the tumor. These processes initiate complicated signaling cascades that interact with each other at level of many signal transducer proteins.

However researchers and practical clinicians repeatedly noted in recent years, that the prescription of targeted drugs to cancer patients, according with incomplete data about the level of expression of individual proteins-oncogenes, may be ineffective due to omission of large number of other oncogenes and onco-suppressors that can neutralize the therapeutic effect of a selected drug.

3. Methods of Microarray Analysis of the Cell Transcriptome

The mere fact of increased oncogenic expression, as well as reduced expression of onco-suppressors and/or mutations of their genes may be insufficient indication for a particular anticancer drug because carcinogenesis is the result of several different mutations of oncogenes and onco-suppressors. On the other hand, transcriptome research methods have established currently in the practice of scientific and clinical studies. Among them are reverse transcription of messenger RNA (mRNA) followed by hybridization on a microchip, hybridization of olygonucleotides, subtractive hybridization of complementary DNA (cDNA), genome screening using libraries of small interfering RNA (siRNA) and cDNA, analysis of alternative promoters and splice sites to search for abnormal genes in signaling pathways, exome sequencing and other. If you apply these methods to study on same platform the sample taken from an tumor of individual patient and the samples of similar tissue taken from a population of healthy people, you can get information about the relative (compared with the normal) level of expression of each of the more than 34 thousand genes in individual patients. In a typical DNA microarray probes are covalently attached to a solid surface such as glass or silicon chip. Other platforms, such as manufactured by the company [symbol] Illumina [symbol] , use microscopic beads instead of large solid surfaces. DNA microarrays are used to analyze change of gene expression, detect single nucleotide polymorphism (SNP), genotype or re-sequence the mutant genomes. Microarrays are different in construction, operation characteristics, accuracy, efficiency and cost. Using DNA microarrays is widespread in molecular biology and medicine. Modern DNA microarray is composed of thousands deoxyoligonucleotides (probes) that are grouped in the form of microscopic points and anchored on the solid substrate. Each point contains several picomoles of DNA with a specific nucleotide sequence. DNA microarray oligonucleotides may be short regions of genes or other functional elements of DNA; they are used to hybridize to the cDNA or mRNA (mRNA). Hybridization of the probe and the target is detected and quantified by using fluorescence or chemiluminescence, which allows to determine the relative amount of a given nucleic acid sequence in a sample.

4. Methods for Quantitative Analysis of Mitogenetic Signaling Pathways

Mathematical modeling of the formation mitogenic signal is carried out in systems biology based on the information about interaction of different proteins and genes carrying mitogenic signals. This information is tabulated in online databases, such as, but not limited to, UniProt, HPRD, QIAGEN SABiosciences, WikiPathways and other. Also systems of management of this database and knowledgebase content were developed such as Ariadne Pathway Studio, SPIKE, Reactome, KEGG, and MetaCore. These databases and knowledge bases provide structuring of information about properties and interactions of proteins and genes, which required for the analysis of mathematical models of mitogenic signals as well as for the estimation of anticancer drugs effect on the signaling pathways. In particular such information is a data about the presence of interesting functional domains and binding sites inside protein molecule, the presence of partners that bind to these sites, the affinity of the protein molecules to each other, as well as the catalytic activity of the molecules. However, being in the database information on the structure and interaction of molecules is not adapted to quickly build and analyze the properties of signaling pathways, which are affected by targeted anticancer drugs. Even such a DBMS as Ariadne Pathway Studio does not include all the necessary methods and algorithms for the analysis of pathological changes in the pro- and anti-mitotic signaling cascades, a fortiori methods required for prediction of targeted anticancer drug efficiency for particular patient.

The multiplicity of sites and domains of signal transducer proteins in pro- and anti-mitotic pathways leads to the following: the structure of these pathways is very complex and branched, and has numerous serial or parallel, independent or competitive acts of molecular interaction. As a result, total graph of interaction of signal transducer proteins may be linear or branched. The role of each signal transducer protein in the mitogenic paths depends on the nature of his interaction with partner proteins (serial or parallel). Nevertheless, the task of accounting of the interaction between the mitogenic signal transducer proteins is very complex, and its solution cannot always be unambiguous. When you solve this task, you must take into account different details of protein-protein interactions for signal-carrying molecules, which hitherto are the subject of discussion within the community of experts examining these pathways. Furthermore, it is a complex and ambiguous estimation of the weighting factors describing the importance of a particular transducer protein. Therefore, to support decision regarding targeted anticancer drugs OncoFinder system uses a different approach, which takes into account only the general protein or gene role in the formation of pro- or anti-mitotic signal (but not the position of a protein/gene on the general scheme of protein-protein interactions).

5. Key Quantitative Indicators Calculated OncoFinder System

When calculating the quantitative indicators of pathological changes in pro- and anti-mitotic signaling pathways for individual cancer patients, as well as the ability of anticancer drugs to compensate for these changes, OncoFinder system uses the following assumptions. First, graph of protein-protein interactions in each signaling pathway is considered as two parallel chains of events: one leads to activation of signaling pathways, other—to inhibition of this pathway. Second, the expression level of signal transducer protein in each pathway is considered in dormant state much smaller than in activation state (thereby each signal transducer protein in dormant state has deeply unsaturated state).

Thus, the OncoFinder system considers signal transducer protein of each pathway as having equal opportunities cause the activation/inhibition of pathway. Under these assumptions, based on the law of mass action next assessment of pathological changes in the signal pathway (signal outcome, SO) can be proposed,

$$SO = \frac{{\prod }_{i = 1}^{N} {[ AGEL ]}_{i}}{{\prod }_{j = 1}^{M} {[ AGEL ]}_{j}} .$$

In this equation the multiplication is performed over all the genes of activators and inhibitors of the signal present in the pathway, [AGEL]ᵢ (activator gene expression level) and [RGEL]ⱼ (repressor gene expression level) are expression level of activators gene [symbol] o i [symbol] o j, correspondingly.

Spend the logarithm for the transition from multiplicative value to additive relative mitogenic significance of cascade (pathway mitogenic strength), which serves to evaluate the degree of pathological changes in the signal pathway:

$${PMS}_{p} = {AMCF}_{p} {\sum }_{n} {NII}_{np} \cdot {ARR}_{np} \cdot {BTIF}_{n} \cdot lg ( {CNR}_{n} ) .$$

Here CNRₙ (cancer(case)-to-normal ratio) is the ratio of expression levels of a gene, encoding a protein n, from individual patient to norm (mean value of the control group). Discrete value BTIF (beyond tolerance interval flag) is calculated as:

$${BTIF}_{n} = \{ \begin{matrix}0 , & {CNR}_{n} lays within the toleranceinterval \\ 1 , & {CNR}_{n} lays outsidethetoleranceinterval\end{matrix} \}$$

Discrete value ARR (activator/repressor role) is defined as follows and stored in the database mitogenetic pathways:

ARR=−1, protein n is the repressor of the pathway p

ARR=−0.5, protein n is rather repressor of the pathway p

ARR=0, protein is neither repressor nor activator of the pathway p

ARR=0.5, protein n is rather activator of the pathway p

ARR=1, protein n is the activator of the pathway p

Discrete value AMCF (activation-to-mitosis conversion factor):

AMCF=−1, activation prevents mitosis

AMCF=1, activation activates mitosis

6. Prognostic Evaluation of Clinical Efficacy of Targeted Anticancer Drugs

We can suggest two ways to forecast the clinical efficacy of anticancer drugs. First, drug will be clinically effective if it compensates pathological changes in the signaling pathways, leading them back to normal. For monoclonal antibodies (mabs) and kinase inhibitors (nibs) assessment of the ability of drugs reverse pathological changes in the signaling pathways to the norm is the value of DS1 (drug score 1):

$$DS {1}_{d} = {\sum }_{t} {DTI}_{dt} {\sum }_{p} {NII}_{tp} \cdot {PMS}_{p}$$

here d—drug number, t—number of target protein, p—signaling pathway number.

Discrete value drug-target index

DTI=0, drug d has no target on the protein t

DTI=1, drug d has the target(s) on the protein t

Discrete value node involvement index

NII=0, there is no protein t in the pathway p

NII=1, there is a protein t in the pathway p

For “killer-mabs” drugs value DS1 is calculated as:

$$DS {1}_{d} = {\sum }_{t} {DTI}_{dt} {\sum }_{p} {NII}_{tp} \cdot PM / {S}_{p}^{″} ¿ , \\ PM / {S}_{p}^{″} = {\sum }_{n} {NII}_{np} \cdot {BTIF}_{n} \cdot lg ( {CNR}_{n} ) ¿ ,$$

that is at calculation of DS1 all values AMCF and ARR equal 1.

For activator drugs DS1 taken with the opposite sign relative to inhibitors:

$$DS {1}_{d} = - {\sum }_{t} {DTI}_{dt} {\sum }_{p} {NII}_{tp} \cdot {PMS}_{p} .$$

Otherwise prediction of clinical efficacy of anticancer drug is the ability DS2 (drug score 2) of the drug to reduce the proliferative (mitotic) cell activity. For mabs and nibs DS2 can be estimated by the following equation:

$$DS {2}_{d} = {\sum }_{t} {DTI}_{dt} {\sum }_{p} {NII}_{tp} \cdot {AMCF}_{p} \cdot {ARR}_{tp} \cdot {BTIF}_{t} \cdot lg ( {CNR}_{t} )$$

For “killer-mabs” this ability can be estimated as:

$$DS {2}_{d} = {\sum }_{t} {DTI}_{dt} {\sum }_{p} {NII}_{tp} \cdot {BTIF}_{t} \cdot lg ( {CNR}_{t} )$$

For activator drugs value DS2 should be taken with the opposite sign:

$$DS {2}_{d} = - {\sum }_{t} {DTI}_{dt} {\sum }_{p} {NII}_{tp} \cdot {AMCF}_{p} \cdot {ARR}_{tp} \cdot {BTIF}_{t} \cdot lg ( {CNR}_{t} )$$

7. Structure of OncoFinder System Databases

OncoFinder system databases contain following information (see tables 1-3).

TABLE 1
Structure of drug database of OncoFinder system

| [symbol] | Database field |
|---|---|
| 1 | Drug ID |
| 2 | Drug name |
| 3 | Drug type: |
| | 1-mab (monoclonal antibody) |
| | 2-<<killer-mab>> (comlex antibody with cytotoxic agent) |
| | 2-a small molecule inhibitor (nib-kinase inhibitor, antibiotic, etc.) |
| | 4-activator (a hormone, a vitamin, an interleukin, a cytokine, etc.) |
| 4 | Active substance |
| 5 | Targets (genes and proteins that are affected by drug) |
| 6 | Morphology and localization of diseases for which the drug is intended |
| 7 | The cost of one course |
| 8 | Side effect |
| 9 | Contraindication |
| 10 | Compatibility with other drugs |
| 11 | Clinical experience |
| 12 | Availability on the market |
| 13 | Source of information |

TABLE 2
Structure of signaling pathways database of OncoFinder system

| [symbol] n/n | Database field |
|---|---|
| 1 | Pathway ID |
| 2 | Pathway name |
| 3 | Role of the pathway activation in the mitogenesis (AMCF) |
| 4 | Source of information |

TABLE 3
Structure of signaling pathways genes database of OncoFinder

| [symbol] o n/n | Database field |
|---|---|
| 1 | ID gene encoding signal transducer protein |
| 2 | Name of gene encoding signal transducer protein |
| 3 | Name of signal transducer protein |
| 4 | Gene/protein role in activation of pathway (ARR) |

The following database is used for a graphical representation of pathological changes in the signaling pathways (see table 4).

TABLE 4
Structure of database for a graphical representation of pathological
changes in the signaling pathways

| [symbol] o n/n | Database field |
|---|---|
| 1 | Name graph node of signaling pathways (protein or proteins |
| | complex) |
| 2 | Name of genes included into this node |
| 3 | Number of connection-arrow (ratio of activation or |
| | inhibition) between nodes of signaling pathways graph |
| 4 | Name of start and end nodes for this connection |

8. The Main Menu of OncoFinder System

OncoFinder system consists of two main parts—the client and the administrative.

8.1. The Client Part of the Oncofinder System

The client part contains menu options [symbol] New Calculation [symbol] , [symbol] History [symbol] , [symbol] Biochem DB [symbol] , [symbol] Drugs DB [symbol] .

Menu [symbol] New Calculation [symbol] .

Menu [symbol] New Calculation [symbol] serves to enter in system results of new examination (e.g., in an Excel spreadsheet format, or in CSV delimited in the form of a tab, comma or semi). Column input for normal tissue must be of the form [symbol] Norm[name of norm]AVG_Signal [symbol] , and for tumor—with prefix [symbol] Tumour[tumor name]AVG_Signal_ [symbol] ) (see Appendix A). Menu [symbol] Calculation History [symbol] serves calculation of PMS′, PMS, DS1 and DS2 values for any of the samples entered into the system.

Numerous options of menu “Calculation results” allow for each selected patient output and save (by moving the mouse cursor over the column and then copy to the clipboard) information about differentially (compared with the norm) expressed genes, PMS and PMS' values, DS1 and DS2 values. A separate diagram displays information about 10 signaling pathways contributing to the greatest extent (in the upper part of the diagram) and preventing to mitogenesis. Pathways contributing to mitogenesis are considered activated promitotic and reduced antimitotic signaling pathways, and pathways preventing to mitogenesis—on the contrary, activated antimitotic and reduced promitotic signaling pathways.

8.2. Administrative Part of OncoFinder System

It is intended to add new, edit and delete unnecessary items in databases (such as in databases 191 (FIG. 1). The contents of a signaling pathways databases, genes in signaling pathways, nodes of their graphs, activating and inhibitory connections (“arrows”) between them, components of nodes of the signaling pathways graph, as well as anticancer drugs are all constructed and configured to be edited. A user 141 (FIG. 1) can update data from phone 140, or computer 112, 160, for example.

The present invention provides a new biomathematical method, OncoFinder, for both quantitative and qualitative analysis of the intracellular signaling pathway activation (SPA). This method is universal and may be used for the analysis of any physiological, stress, malignancy and other perturbed conditions at the molecular level. In contrast to the other existing techniques for aggregation and generalization of the gene expression data for individual samples, we suggest to distinguish the positive/activator and negative/repressor role of every gene product in each pathway. We show that the relative importance of each gene product in a pathway can be assessed using kinetic models for “low-level” protein interactions. Although the importance factors for the pathway members cannot be so far established for most of the signaling pathways due to the lack of the required experimental data, we showed that ignoring these factors can be sometimes acceptable and that the simplified formula for SPA evaluation may be applied for many cases. We hope that due to its universal applicability, the method OncoFinder will be widely used by the researcher community.

Here a new method is provided which makes it possible to quantitatively estimate SPA for individual samples basing on the large-scale gene expression data. Theoretically, the signal transduction efficiency at every stage of the SP depends on the concentrations of the interacting gene products. The computational modeling of the signal transduction processes indicated that most of the interacting proteins can be found in the living cells at the concentrations significantly lower than the saturation levels for each transduction step (Bitwistle, 2007; Borisov, 2009).

The present invention model is based on the correlation of the signal transducer concentrations and the overall SPA. The overall individual roles of certain gene products in the functioning of each individual SP, were determined, according to some aspects of the present invention. These roles can be either positive or negative signal transduction regulators; alternatively, for some proteins the roles may be undefined or neutral. Finally, these roles may be characterized quantitatively depending on the individual importance of the individual interactors in the overall SPA. The determination of these roles for each individual SP is a non-trivial task that has several uncertainties. Namely, protein interactions within each pathway may be competitive or independent, and therefore, belong to a sequential or parallel series of the nearby events (Borisov, 2006, Conzelman, 2006). The overall graph for the protein interaction events may include both sequential (pathway-like) and parallel (network-like) edges (Borisov, 2008; Conzelman, 2006). The role of each gene product in the signal transduction may depend on whether it works in a sequential or a parallel way.

Alternatively, as the raw approximation of this situation, one may propose a simplified method that utilizes only the overall roles of each gene product in the SPA. In this case, each simplified signaling graph includes only two types of branches of protein interaction chain: one for sequential events that promote SPA, and another for repressor sequential events. Under these conditions, it can be presumed that all activator/repressor members have equal importance for the SPA, and come to the following formula for the overall signal outcome (SO) of a given pathway,

$$SO = \frac{{\prod }_{i = 1}^{N} {[ AGEL ]}_{i}}{{\prod }_{j = 1}^{M} {[ AGEL ]}_{j}} .$$

Here the multiplication is done over all possible activator and repressor proteins in the pathway, [AGEL]ᵢ and [RGEL]ⱼ are relative gene expression levels of activator (i) and repressor (j) members, respectively. To obtain an additive value, it is possible to take the logarithmic levels of gene expression, and thus come to a function of pathway activation strength, PAS, which operates with the experimental datasets obtained during comprehensive profiling of gene expression, for a pathway p,

$${PAS}_{p} = {\sum }_{n} {ARR}_{np} \cdot 1 g ( {CNR}_{n} ) .$$

Here the case-to-norm ratio, CNRₙ, is the ratio of the expression levels of a gene n in the sample (e.g., of a cancer patient) and in the control (e.g., average value for healthy group). The discrete value ARR (activator/repressor role) shows whether the gene product promotes SPA (1), inhibits it (−1) or plays an intermediate role (0.5, 0 or −0.5, respectively). Negative and positive overall PAS values correspond, respectively, to decreased or increased activity of SP in a sample, with the extent of this activity proportional to the absolute value of PAS.

However, the assumption of sequential protein-protein interaction in pathways may seem rather artificial. Although it is difficult to precisely estimate the importance of certain gene products that act in the pathway in a non-sequential mode, the solution may come from the kinetic models of SPA that use the “low-level” approach of mass action law describing each act of protein interactions. Some of these models were previously experimentally validated by us and others using Western blot analisis (Kholodenko, 1999; Kiyatkin, 2006; Bitwistle, 2007; Borisov, 2009; Kuzmina, 2011). Our previous experience suggests that the two models are especially effective for this task. One of them operates with the concept of sensitivity of the ordinary differential equation system with the free parameters (Kholodenko, 2003), which is generally applied to kinetic constants, but may be used for assperating with the protein concentrations in the kinetic model of a pathway (Kuzmina, 2011), according to a formula,

$${w}_{j}^{( 1 )} = {lim}_{t \to ∞} \frac{1}{T} {\int }_{0}^{T} \vert \frac{\partial ln [ EFF ( t ) ]}{\partial ln {C}_{j}^{tot}} \vert dt .$$

Here w is the importance factor, [EFF(t)] is the time-dependent concentration of the active pathway effector protein (experimentally traced marker of a pathway activation), and Cⱼ^{tot} is the total concentration for the protein j.

Another way to calculate the importance factor for the gene products deals with the stiffness/sloppiness analysis of the effector activation (Daniels, 2008). This approach comprises analyzing the Hesse matrix,

$${H}_{ij} = \frac{{\partial }^{2}}{\partial {C}_{i}^{tot} \partial {C}_{j}^{tot}} {\sum }_{k} \frac{{( [ EFF ( {C}^{tot} , {t}_{k} ) ] - {[ EFF ]}_{k}^{exp} )}^{2}}{{σ}_{k}^{2}} ,$$

where C^{tot} is the vector of total concentrations for every protein in the pathway, [EFF(C^{tot},tₖ)] is concentration of an active pathway effector protein at the time point tₖ, [EFF]ₖ^{exp} is the experimentally measured (e.g., by Western blots) total concentration of the effector at the same time, and σₖ is the experimental error for this measurement. The sloppiness/stiffness analysis looks for the eigenvalues, □ₘ, and eigenvectors, □ₘ, for the Hesse matrix, Hξₘ=λₘ·ξₘ. The higher is the absolute value of □ₙ, the “stiffer” is the direction within the n-dimensional space of C^{tot} (where n is the number of protein types in the pathway model). The eigenvector components along with the stiffest direction, □ₛ, may be used for assessment of the importance factor w of a certain gene products in a pathway according to the formula: wⱼ⁽²⁾=|ξ_{s j}|.

Taking into account the above considerations, we come to the following final formula for assessing the SPA:

$${PAS}_{p}^{( 1 , 2 )} = {\sum }_{n} {ARR}_{np} \cdot {BTIF}_{n} \cdot {w}_{n}^{( 1 , 2 )} \cdot 1 g ( {CNR}_{n} ) .$$

Here the Boolean flag BTIF (beyond tolerance interval flag) indicates that the expression level for the gene n for the given sample is different enough from the respective expression level in the reference sample or set of reference samples. For this demonstration of our method we applied two simultaneous restriction/inclusion criteria to the expression of each individual gene: (i) 50% expression level cut-off rate compared to the average for the reference set, and (ii) the sample expression level should differ stronger than two standard deviations from the average of the reference set.

We next explored the effect of the introduction of the importance factors w in calculating PAS compared to the simplified model of PAS evaluation lacking w. Importance factors were calculated using either sensitivity-based, w⁽¹⁾, or stiffness-based, w⁽²⁾, algorithms. We performed this verification for the EGFR pathway, for which we established and published this model previously (Kuzmina, 2011). For these two sets of the importance factors, and for the w-free model, we performed a computational analysis of nine transcriptomes established using microarray hybridization technology for human glioblastoma samples from the published datasets (Supplementary dataset 1). The information on SP organization was taken from the Web-based SABiosciences database. The data on ARR were manually curated by analizing the same database. Our findings suggest that the cloud of values for the ratio

$$\frac{{PAS}_{EGFR}^{( 1 )}}{{PAS}_{EGFR}}$$

(where PAS_{EGFR} is the PAS value for the EGFR pathway in the simplified model, where all importance factors equal to 1) lies within the interval of (0.6±0.8), whereas the ratio

$$\frac{{PAS}_{EGFR 1}^{( 2 )}}{{PAS}_{EGFR 1}}$$

belonged to the interval (1.0±0.8). Overall, we conclude that for such a complex SP like EGFR which includes >300 gene products, incorporation of the importance factors had only a moderate effect on the PAS. This suggests that, in principle, the simplified formula for PAS calculation may be applied for the pathway analysis.

For the overwhelming majority of the SPs, there is no experimental data available that makes impossible for them to calculate the importance factors using kinetic models. For them we performed the stochastic robustness analysis using the simplified formula for PAS. We introduced the additional random perturbation factor, wₙ, which was used as the analog of importance factor for PAS evaluation. In our computational simulation, the distribution of wₙ was logarithmically normal and calculated as follows: wₙ=2^{x}^{ₙ}, where xₙ were normally distributed random numbers with the expected value of M=0 and standard deviation σ=0.5. The random perturbation factors wₙ were applied to the glioblastoma transcriptional dataset GSM215422. Importantly, although the perturbation was done independently 98 times with independent weighting factors wₙ, for each gene, the values of standard deviation for the set of alternate PAS (APAS) were nor big enough to mask the proportional trend between the average perturbed PAS and unperturbed PAS for each of the 68 signaling pathways analyzed in this study (see Buzdin et al, 2014 and Borisov et al., 2014).

We propose here a new biomathematical method, OncoFinder, for both quantitative and qualitative analysis of the intracellular signaling pathway activation. It can be used for the analysis of any physiological, stress, malignancy and other perturbed conditions at the molecular level. The enclosed mathematical algorithm enables processing of high-throughput transcriptomic data, but there is no technical limitation to apply OncoFinder to the proteomic datasets as well, when the developments in proteomics allow generating proteome-wide expression datasets. We hope that due to its universal applicability, the method, OncoFinder, will be widely used by the biomedical researcher community and by all those interested in thorough characterization of the molecular events in the living cells. We also want to encourage building international scientific partnership aimed at the standardized experimental characterization of the importance factors for individual proteins, starting at least with the SPs most relevant to the major aspects of human physiology.

Prognostic Evaluation of Clinical Efficacy of Targeted Anticancer Drugs

The systems and methods of the present invention provide two ways to forecast the clinical efficacy of anticancer drugs. First, drug will be clinically effective if it compensates pathological changes in the signaling pathways, leading them back to normal. For monoclonal antibodies (mabs) and kinase inhibitors (nibs) assessment of the ability of drugs reverse pathological changes in the signaling pathways to the norm is the value of DS1 (drug score 1):

$$DS {1}_{d} = {\sum }_{t} {DTI}_{dt} {\sum }_{p} {NII}_{tp} \cdot {PMS}_{p}$$

here d—drug number, t—number of target protein, p—signaling pathway number.

Discrete value drug-target index (DTI)=0, drug d has no target on the protein t

=1, drug d has the target(s) on the protein t

Discrete value node involvement index

NIIₜₚ equals to either 1 when the particular protein t participates in the pathway p, or 0 when protein t is not involved in the pathway p

For “killer-mabs” drugs value DS1 is calculated as:

$$DS {1}_{d} = {\sum }_{t} {DTI}_{dt} {\sum }_{p} {NII}_{tp} \cdot PM \text{/} {S}_{p}^{″} ¿ , \\ PM \text{/} {S}_{p}^{″} = {\sum }_{n} {NII}_{np} \cdot {BTIF}_{n} \cdot 1 g ( {CNR}_{n} ) ¿ ,$$

that is at calculation of DS1 all values AMCF and ARR equal 1.

For activator drugs DS1 taken with the opposite sign relative to inhibitors:

$$DS {1}_{d} = - {\sum }_{t} {DTI}_{dt} {\sum }_{p} {NII}_{tp} \cdot {PMS}_{p} .$$

Otherwise prediction of clinical efficacy of anticancer drug is the ability DS2 (drug score 2) of the drug to reduce the proliferative (mitotic) cell activity. For mabs and nibs DS2 can be estimated by the following equation:

$$DS {2}_{d} = {\sum }_{t} {DTI}_{dt} {\sum }_{p} {NII}_{tp} \cdot {AMCF}_{p} \cdot {ARR}_{tp} \cdot {BTIF}_{t} \cdot 1 g ( {CNR}_{t} )$$

For “killer-mabs” this ability can be estimated as:

$$DS {2}_{d} = {\sum }_{t} {DTI}_{dt} {\sum }_{p} {NII}_{tp} \cdot {BTIF}_{t} \cdot 1 g ( {CNR}_{t} )$$

For activator drugs value DS2 should be taken with the opposite sign:

$$DS {2}_{d} = {\sum }_{t} {DTI}_{dt} {\sum }_{p} {NII}_{tp} \cdot {AMCF}_{p} \cdot {ARR}_{tp} \cdot {BTIF}_{t} \cdot 1 g ( {CNR}_{t} )$$

7. Structure of OncoFinder System Databases

OncoFinder system databases contain following information (see tables 1-4 hereinabove).

Example of the OncoFinder system 100 (FIG. 1) use for an individual clinical case

Analysis report: Patient N *****

August 2013

Identity number: ********

Disclaimer

*The information provided in this report is intended solely for the use by the certified specialists in the fields of oncology, genetics, and molecular medicine. This report may not be used for drug proscription, appointing therapeutic strategies, etc, except when interpreted by a medical doctor. Our research and production team will be happy to help in case of any doubts or uncertainties.

### Contents

General information

Tumor phenotype

Adjustment of medications for individual tumor

Description of selected drugs

Clinical trials of other drugs for the therapy of kidney cancer

Appendix 1. Diagrams of pathways most strongly activated in a patient

Appendix 2. List of Drug Scores calculated for individual patient

### Example 1. Whole List of Activation Indexes for Intracellular Signaling Pathways

(PMS) calculated for a patient

Conclusions on the individual case

General Information

Diagnosis

Kidney cancer; right kidney

Description of patient and disease

Sex: male (called patient X)

Age: 57 years

Diseases stage: stage IV, pT3aN0M1 (detected lung metastases; clear cell renal cell carcinoma with necrotic areas, invasion of renal pelvis and infiltrative growth, walls of large vena with thrombosis, renal capsular invasion without peripheral infiltration.

Previous treatment: kidney removal (nephrectomy); chemotherapy

Moment of biomaterial sampling for the analysis: 6 samples of biomaterial: all paraffin-embedded tissue blocks obtained upon kidney removal before chemotherapy (7 months prior this investigation).

Tumor Phenotype

Gene expression phenotype of the patient's tumor was investigated. The table contains 10 intracellular signaling pathways showing the largest deviations from the set of normal tissues from unrelated healthy donors (5 upregulated and 5 downregulated signaling pathways). PMS (Pathway Manifestation Strength) is the activation index for intracellular pathways, maximal PMS corresponds to the maximal activation level.

TABLE 5
Results of upregulated/down-regulated pathways for Patient X

| THE MOST | | |
|---|---|---|
| ABERRANT | | |
| PATHWAYS (5 | | |
| UPREGULATED, | | |
| 5 DOWN- | SHORT SUMMARY, RELATION TO | |
| REGULATED) | TUMOR PHENOTYPE | PMS |
| ERK | One of the major signaling pathways in | 103.0 |
| | MAPK-signaling, one of the main | |
| | regulators of cell growth and differentiation. | |
| | The pathway is aberrantly activated in most | |
| | cases the cancer. | |
| P38_p | It is option of P38 signaling pathway | 78.7 |
| | stimulating cell survival. It is started in | |
| | response to stimulation by IL-1, | |
| | inflammatory cytokines, stress, ultraviolet | |
| | radiation, and GPCR ligands stimulation | |
| | by growth factors, upon antigenic stimulation | |
| | of T cells. The pathway activate NFkB, STAT | |
| | and Ras proliferative pathways. It leads to | |
| | the survival and growth of cells, to the | |
| | reorganization of the cytoskeleton. | |
| GSK3 | GSK3 kinase signaling pathway triggered by | 78.3 |
| | growth factors, WNT signaling pathway and | |
| | cadherin signaling. As a result, the signaling | |
| | pathway activate pathways PI3K, Akt/PKB, | |
| | Ras, activate beta-catenin, GSK3 kinase | |
| | inhibition occurs. It enhances cell division. | |
| AKT | One of the key signaling pathways are often | 73.2 |
| | activated in cancer. Is started in response to | |
| | external stimulation by cytokines, ligands | |
| | GPCR, integrins, growth factors. As a result, | |
| | cell growth and division are stimulated, | |
| | apoptosis is blocked. Import glucose and | |
| | glycogen synthesis are enchanced. | |
| | Intracellular protein p53 is destroyed. | |
| | Signaling pathway NF-kB is stimulated. | |
| cAMP | This signaling pathway is triggered in | 70.2 |
| | response to glucagon stimulation, Netrin 1, | |
| | epinephrine and norepinephrine, in response | |
| | to stress, hormonal stimulation, | |
| | inflammatory markers, growth factors, | |
| | ligands of GPCR. As a result, activation | |
| | enhances cell growth and stimulates | |
| | glycolysis, fatty acid metabolism, cytokine | |
| | production, chemotaxis and enhances | |
| | degradation of the negative regulators of | |
| | the cell cycle. Signaling pathways P38, | |
| | mTOR, Rap1, Rap2, Akt are activated. | |
| Ubiquitin- | Pathway of ubiquitinilation and proteasomal | −28.4 |
| Proteasome | degradation provides directional destruction | |
| | of target proteins in cell. The imbalance | |
| | of this mechanism is often observed | |
| | in cancer, in case of decreasing the activity | |
| | of the mechanism it leads to increasing the | |
| | concentration of positive regulators of | |
| | cell division, for example, cyclin E. | |
| RNA | RNA polymerase complex promotes | −12.9 |
| Polymerase II | transcription of genes, i.e. the formation | |
| | of mRNA copies, which is a step prior | |
| | to protein synthesis. Reduced activity | |
| | of the RNA polymerase can be | |
| | associated with a slowing of cell | |
| | growth and tissue aging. | |
| WNT | This signaling pathway is initiated in | −10.0 |
| | response to stimulation with family | |
| | proteins WNT. As a result, the activation | |
| | of beta-catenin and signaling pathway Rac1, | |
| | RhoA, JNK, Caln, PKC, NFAT occurs. | |
| | Cell viability, cell proliferation, | |
| | differentiation and adhesion are enchanced. | |
| | The activation of this signaling pathway | |
| | is often associated with the progression | |
| | of various forms of cancer. | |
| Mismatch | Pathway of cellular DNA mismatch-repair. | −6.5 |
| repair | This process helps to deal with the | |
| | emergence of mutations in DNA and to | |
| | maintain the integrity of the genome. | |
| | Block repair increases variability of | |
| | cancer cells and can serve as a | |
| | unfavorable sign. | |
| Caspase | Caspase regulatory cascade is one of the | −6.1 |
| cascade | main components of apoptosis. | |
| | Apoptosis is programmed cell death. | |
| | One of the main apoptosis functions | |
| | is destruction the defective (damaged, | |
| | mutant, infected, cancerous) cells. | |

Adjustment of Medication for Patient X's Tumor

The patient's data were analyzed by our original innovative algorithm OncoFinder™. Ten target drugs showing the best score and predicted to be the most efficient for the treatment of the individual patient's tumor were selected. Totally 94 target drugs were analyzed. Drug-score is the quantitative estimate of the drug efficiency for the individual cancer. The Drug-score index values varied from −122 to 3312 with the average value 321. Ten clinically used target cancer therapeutics with the highest values of the Drug-score index, are shown below. The higher values of Drug-score index correspond to increased predicted efficiency of drugs.
Sorafenib (Drug-score=3312)
Regorafenib (Drug-score=3032)
Sunitinib (Drug-score=2906)
Pazopanib (Drug-score=2200)
Imatinib (Drug-score=1880)
Dasatinib (Drug-score=1768)
Vandetanib (Drug-score=1350)
Trastuzumab (Drug-score=1292)
Lapatinib (Drug-score=1182)
Flavopiridol (Drug-score=1026)

Description of Selected Drugs, their Use for Renal Cancer Therapy and for Other Cancer Types

### 1. Sorafenib (Nexavar)

Sorafenib is a small molecular inhibitor of several tyrosine protein kinases (VEGFR and PDGFR) and Raf kinases (intracellular serine/threonine kinases), also is a unique inhibitor of Raf/Mek/Erk pathway (MAPK pathway). Sorafenib is a drug approved for the treatment of primary kidney cancer (advanced renal cell carcinoma), advanced primary liver cancer (hepatocellular carcinoma), and radioactive iodine resistant advanced thyroid carcinoma.

The results of the following clinical trials of sorafenib in therapy of renal cell carcinoma:

A Phase II Study of Sorafenib in Patients With Metastatic Renal Cell Carcinoma (RCC) Refractory to SU11248 (Sunitinib) or Bevacizumab Therapy http://www.clinicaltrials.gov/ct2/show/study/NCT00866320

Participants: 49 (36 f, 13 M), mean age—63.2 years.

Reduction in tumor burden equal to or larger than 5% at 8 weeks (2 cycles of treatment) was observed for 30% from 47 participants.

Median overall survival was 16 months for 47 participants.

Median time to progression was 4.4 months for 47 participants.

Duration of overall response (tumor burden reduction) was 7.1 months for 14 participants.

Serious adverse events were observed for 4 from 47 participants (8.51%).

Locations:
USA
Cleveland Clinic Taussig Cancer Institute, Case Comprehensive Cancer Center, Cleveland, Ohio, United States, 44106
Baylor Sammons Cancer Center, Dallas, Tex., United States, 75246
   A Multicenter Uncontrolled Study of Sorafenib in Patients With Unresectable and/or Metastatic Renal Cell Carcinoma http://www.clinicaltrials.gov/ct2/show/study/NCT00586105

Participants: 39 (9 f, 30 M), mean age—58 years.

Median progression free survival was 5.5 months for 39 participants.

Median overall survival was 7.8 months for 39 participants.

Median time to progression was 5.5 months for 39 participants.

Partial response was observed for 5 from 39 participants, stable disease—for 27, progressive disease—for 6 participants.

Median overall response duration was 7.4 months for 5 participants.

Median time to objective response was 1.4 months for 5 participants.

Serious adverse events were observed for 12 from 39 participants (30.77%).
Locations:
China
Nanjing, Jiangsu, China, 210003
Beijing, China, 100021
Shanghai, China, 200127
Shanghai, China, 200032
Taiwan
Tainan, Taiwan, 70428
Taipei, Taiwan, 10002
Taipei, Taiwan, 112
Taoyuan, Taiwan, 333
   A Randomised, Open-label, Multi-centre Phase II Study of BAY43-9006 (Sorafenib) Versus Standard Treatment With Interferon Alpha-2a in Patients With Unresectable and/or Metastatic Renal Cell Carcinoma http://clinicaltrials.gov/ct2/show/study/NCT00117637

Participants: 189 (72 f, 117 M), mean age—62 years. 97 participants received 400 mg Sorafenib daily until progression in and then 600 mg Sorafenib daily ( [symbol] Sorafenib 400-600 [symbol] ). 92 participants received 9 MU Interferon until progression in and then 400 mg Sorafenib daily ( [symbol] Interferon-Sorafenib [symbol] ).

Median progression-free survival based on Independent Radiological Review for the first intervention period was 5.7 months for 97 participants of [symbol] Sorafenib 400-600 [symbol] group and 5.6 months for 92 participants of [symbol] Interferon-Sorafenib [symbol] group.

Disease control according to Independent Central Review for the first intervention period was observed for 77 from 97 participants of [symbol] Sorafenib 400-600 [symbol] group (5—partial response, 72—stable disease) and for 59 from 92 participants of [symbol] Interferon-Sorafenib [symbol] group (1—complete response, 7—partial response, 51—stable disease). The differences between groups were statistically significant.

Disease control according to the Investigator Assessment for the second intervention period was observed for 25 from 49 participants of [symbol] Sorafenib 400-600 [symbol] θ group (25—stable disease) and for 49 from 61 participants of [symbol] Interferon-Sorafenib [symbol] group (1—complete response, 11—partial response, 37—stable disease).

Median progression-free survival according to the Investigator Assessment for the second intervention period was 4.5 months for 49 participants of [symbol] Sorafenib 400-600 [symbol] group and 5.5 months for participants of [symbol] Interferon-Sorafenib [symbol] group.

Median overall survival was 14.8 months for 97 participants of [symbol] Sorafenib 400-600 [symbol] group and 26.9 months for 92 participants of [symbol] Interferon-Sorafenib [symbol] group. The differences between groups were statistically significant.

Median duration of response according to the Independent Radiological Review for the first intervention period was 7.5 months for 5 participants of [symbol] Sorafenib 400-600 [symbol] group and 7.7 months for 8 participants of [symbol] Interferon-Sorafenib [symbol] group.

Median time to response according to the Independent Radiological Review for the first intervention period was 1.8 months for 5 participants of [symbol] Sorafenib 400-600 [symbol] group and 5.4 months for 8 participants of [symbol] Interferon-Sorafenib [symbol] group.

Median time to response according to the Investigator Assessment for the second intervention period was 1.7 months for 12 participants of [symbol] Interferon-Sorafenib [symbol] group and median overall response duration was 5.5 months.

Serious adverse events were observed for 47 from 97 participants (48.45%) of [symbol] Sorafenib 400-600 [symbol] group for the first intervention period and for 14 from 49 (28.57%) for the second intervention period. Serious adverse events were observed for 36 from 90 (40.00%) participants of [symbol] Interferon-Sorafenib [symbol] group for the first intervention period and for 30 from 61 (49.18%) for the second intervention period.

42 medical centers participated in the study.

A Phase III Randomized Study of BAY43-9006 (Sorafenib) in Patients With Unresectable and/or Metastatic Renal Cell Cancer http://clinicaltrials.gov/ct2/show/study/NCT00073307

Participants: 903 (248 f, 655 M), mean age—59 years. 451 participants received Sorafenib ( [symbol] Sorafenib [symbol] ), other 452 participants received Placebo ( [symbol] Placebo [symbol] ).

Median overall survival was 542 days for 451 participants of [symbol] Sorafenib [symbol] group and 461 days for 452 participants of [symbol] Placebo [symbol] group.

Median progression free survival was 167 days for 384 participants of [symbol] Sorafenib [symbol] group and 84 days for 385 participants of [symbol] Placebo [symbol] group.

Partial response and stable disease were observed for 2.1% and 77.9% from 335 participants of [symbol] Sorafenib [symbol] group, only stable disease was observed for 55.2% from 337 participants of [symbol] Placebo [symbol] group.

Serious adverse events were observed for 154 from 451 (34.15%) participants of [symbol] Sorafenib [symbol] group and for 110 from 451 (24.39%) participants of [symbol] Placebo [symbol] group.

121 medical centers participated in the study.

Extension Study for BAY43-9006 (Sorafenib) in Japanese Patients With Renal Cell Carcinoma http://clinicaltrials.gov/ct2/show/study/NCT00586495

Participants: 95 (21 f, 74 M), mean age—62 years.

Median progression free survival was 386 days for 94 participants.

Among the 94 participants had 25 partial response and 64 stable disease.

Median duration of overall response was 419 days for 94 participants.

Median time to response was 84 days for 94 participants.

Number of participants who died from start of treatment of the first subject until 45 months later was 43 from 94 participants.

Serious adverse events were observed in 34 of 95 (35.79%) participants.

41 medical centers of Japan participated in the study.

### 2. Regorafenib (Stivarga)

Regorafenib is an oral multi-kinase inhibitor. Regorafenib is approved by FDA to treat: colorectal cancer that has metastasized, it is used in patients who have not gotten better with other treatments; gastrointestinal stromal tumor that is locally advanced, cannot be removed by surgery, or has metastasized, it is used in patients whose disease has not gotten better with Imatinib mesylate and Sunitinib malate.

The results of the following clinical trial of Regorafenib in therapy of renal cell carcinoma:

A Phase II Uncontrolled Study of BAY73-4506 (Regorafenib) in Previously Untreated Patients With Metastatic or Unresectable Renal Cell Cancer (RCC) http://clinicaltrials.gov/ct2/show/study/NCT00664326

Participants: 49 (22 f, 27 M), mean age—62 years.

Among the 48 participants had partial response for 39.6% and stable disease for 41.7%.

Median progression free survival was 335 days for 49 participants.

Median overall response duration was 428 days for 19 participants.

Median duration of stable disease was 119 days for 25 participants.

Serious adverse events were observed for 30 from 49 participants (61.22%).

Locations:
USA
Los Angeles, Calif., United States, 90033
Houston, Tex., United States, 77030
Finland
Helsinki, Finland, 00029
Turku, Finland, FIN-2052
France
Nantes, France, 44020
Paris, France, 75014
Germany
Frankfurt, Hessen, Germany, 60596
Dresden, Sachsen, Germany, 01307
Berlin, Germany, 10967
Hamburg, Germany, 20246
Poland
Bialystok, Poland, 15-027
Lublin, Poland, 20-090
Poznan, Poland, 60-569
United Kingdom
Bristol, Avon, United Kingdom, BS2 8ED
Leicester, Leicestershire, United Kingdom, LE1 5WW
Northwood, Middlesex, United Kingdom, HA6 2RN
Cambridge, United Kingdom, CB2 0QQ
London, United Kingdom, SE1 9RT

### 3. Sunitinib (Sutent)

Sunitinib is an oral, small-molecule, multi-targeted receptor tyrosine kinase inhibitor (PDGF-Rs [symbol] VEGFRs, c-Kit, RET, CSF-1R, flt3). Sunitinib is a drug FDA approved for the treatment of metastatic renal cell carcinoma, gastrointestinal stromal tumor resistant to Imatinib and pancreatic neuroendocrine tumors (unresectable or metastatic).

The results of the following clinical trial of Sunitinib in therapy of renal cell carcinoma:
A Single-Arm, Open-Label, Multi-Center, Phase Iv, Safety And Efficacy Study Of Sunitinib Malate As First-Line Systemic Therapy In Chinese Patients With Metastatic Renal Cell Carcinoma http://www.clinicaltrials.gov/ct2/show/study/NCT00706706

Participants: 105 (26 f, 79 M), mean age—54.6 years.

Median progression free survival was 61.7 weeks for 105 participants.

Median overall survival was 133.4 weeks for 105 participants.

One year survival probability was 72% for 105 participants.

Objective response (complete or partial) was observed for 31.1% from 103 participants.

Serious adverse events were observed for 13 from 105 participants (12.38%).

11 medical centers of China participated in the study.

A Phase 2 Study Of SU011248 (Sunitinib) In The Treatment Of Patients With Bevacizumab-Refractory Metastatic Renal Cell Carcinoma http://clinicaltrials.gov/ct2/show/NCT00089648

Participants: 61 (27 f, 34 M), age <65 years—43, >65-18 participants.

Complete or partial response was observed for 14 from 61 participants (23%).

Median time to progression was 30.4 weeks for 61 participants.

Median overall response duration was 36.1 weeks for 61 participants.

Median overall survival was 47.1 weeks for 61 participants.

Median progression free survival was 30.4 weeks for 61 participants.

Serious adverse events were observed for 30 from 61 participants (49.18%).

Locations:
USA
Pfizer Investigational Site, Duarte, Calif., United States, 91010
Pfizer Investigational Site, Pasadena, Calif., United States, 91105
Pfizer Investigational Site, San Francisco, Calif., United States, 94115
Pfizer Investigational Site, Chicago, Ill., United States, 60637-1460
Pfizer Investigational Site, Boston, Mass., United States, 02114
Pfizer Investigational Site, Boston, Mass., United States, 02115
Pfizer Investigational Site, Boston, Mass., United States, 02215
Pfizer Investigational Site, Durham, N.C., United States, 27710
Pfizer Investigational Site, Cleveland, Ohio, United States, 44195
Pfizer Investigational Site, Nashville, Tenn., United States, 37232-5536
Pfizer Investigational Site, Dallas, Tex., United States, 75246
   A Pivotal Study Of SU011248 (Sunitinib) In The Treatment Of Patients With Cytokine-Refractory Metastatic Renal Cell Carcinoma http://clinicaltrials.gov/ct2/show/study/NCT00077974

Participants: 106 (39 f, 67 M), age <65 years—87, >65-19 participants.

Complete or partial response was observed for 35 from 106 participants (33%).

Median time to progression was 46.3 weeks for 106 participants.

Median overall response duration was 60.4 weeks for 35 participants.

Median overall survival was 104.1 weeks for 106 participants.

Median progression free survival was 38 weeks for 106 participants.

One year survival probability was 67.2% for 106 participants, two year survival probability—50.2%.

Serious adverse events were observed for 46 from 106 participants (43.40%).

Locations:
USA
Pfizer Investigational Site, Duarte, Calif., United States, 91010-3000
Pfizer Investigational Site, Pasadena, Calif., United States, 91105
Pfizer Investigational Site, San Francisco, Calif., United States, 94115
Pfizer Investigational Site, Boston, Mass., United States, 02114
Pfizer Investigational Site, Boston, Mass., United States, 02115
Pfizer Investigational Site, Boston, Mass., United States, 02215
Pfizer Investigational Site, Ann Arbor, Mich., United States, 48109
Pfizer Investigational Site, Rochester, Minn., United States, 55905
Pfizer Investigational Site, New York, N.Y., United States, 10021
Pfizer Investigational Site, New York, N.Y., United States, 10022
Pfizer Investigational Site, Durham, N.C., United States, 27705
Pfizer Investigational Site, Cleveland, Ohio, United States, 44195
Pfizer Investigational Site, Portland, Oreg., United States, 97213
Pfizer Investigational Site, Philadelphia, Pa., United States, 19111
Pfizer Investigational Site, Madison, Wis., United States, 53792
   Phase II Study Of Single-Agent SU011248 (Sunitinib) In The Treatment Of Patients With Renal Cell Carcinoma http://clinicaltrials.gov/ct2/show/study/NCT00254540

Participants: 51 (19 f, 32 M), aged 20-44 years—5 participants, 45-65 years—28 participants, >65-18 participants. 25 participants had not any prior systemic treatment for renal cell carcinoma ( [symbol] first-line [symbol] ), other 26 had previously been treated with one cytokine-based systemic therapy regimen for renal cell carcinoma ( [symbol] pre-treated [symbol] ).

Among the 25 participants of [symbol] first-line [symbol] group had 1 complete and 11 partial response, among the 26 participants of [symbol] pre-treated [symbol] group had 12 partial response.

Median progression free survival was 53 weeks for 25 participants of [symbol] first-line [symbol] group and 46 weeks for 26 participants of [symbol] pre-treated [symbol] group.

Median overall response duration was 111.6 weeks for 13 participants of [symbol] first-line [symbol] group and 38.1 weeks for 14 participants of [symbol] pre-treated [symbol] group.

Median time to response was 10 weeks for 13 participants of [symbol] first-line [symbol] group and 10.5 weeks for 14 participants of [symbol] pre-treated [symbol] group.

Median overall survival was 143.4 weeks for 25 participants of [symbol] first-line [symbol] group and 141 weeks for 26 participants of [symbol] pre-treated [symbol] group.

Serious adverse events were observed for 28 from 51 participants (54.90%).

Locations:

Japan
Pfizer Investigational Site, Sapporo, Hokkaido, Japan
Pfizer Investigational Site, Tsukuba, Ibaragi, Japan
Pfizer Investigational Site, Osakasayama, Osaka, Japan
Pfizer Investigational Site, Hamamatsu, Shizuoka, Japan
Pfizer Investigational Site, Sunto-gun, Shizuoka, Japan
Pfizer Investigational Site, Chuo-ku, Tokyo, Japan
Pfizer Investigational Site, Akita, Japan
Pfizer Investigational Site, Fukuoka, Japan
Pfizer Investigational Site, Osaka, Japan
Pfizer Investigational Site, Tokushima, Japan
Pfizer Investigational Site, Yamagata, Japan
   A Phase 2 Efficacy And Safety Study Of SU011248 (Sunitinib) Administered In A Continuous Daily Regimen In Patients With Cytokine-Refractory Metastatic Renal Cell Carcinoma http://clinicaltrials.gov/ct2/show/study/NCT00137423

Participants: 107 (19 f, 88 M), mean age—58.2 years. 54 participants received Sunitinib in the morning ( [symbol] AM dose [symbol] ), other 53 received Sunitinib in the evening ( [symbol] PM dose [symbol] ).

Among the 54 participants of [symbol] AM dose [symbol] group had 15 complete or partial response (28.3%), among the 53 participants of [symbol] PM dose [symbol] group had 6 complete or partial response (11.5%).

Median overall response duration was 24 weeks for 54 participants of [symbol] AM dose [symbol] group and 32 weeks for 53 participants of [symbol] PM dose [symbol] group.

Median progression free survival was 35.7 weeks for 54 participants of [symbol] AM dose [symbol] group and 35.3 weeks for 53 participants of [symbol] PM dose [symbol] group.

Median overall survival was 91.4 weeks for 54 participants of [symbol] AM dose [symbol] group and 76.4 weeks for 53 participants of [symbol] PM dose [symbol] group. 1-year survival rate was 77.4% and 66%.

Serious adverse events were observed for 21 out of 54 participants of [symbol] AM dose [symbol] group and for 20 from 53 participants of [symbol] PM dose [symbol] group.

Locations:
USA
Pfizer Investigational Site, Stanford, Calif., United States, 94305
Pfizer Investigational Site, Las Vegas, Nev., United States, 89135
France
Pfizer Investigational Site, Villejuif, France, 94805
Germany
Pfizer Investigational Site, Berlin, Germany, 10117
Pfizer Investigational Site, Muenchen, Germany, 81664
Greece
Pfizer Investigational Site, Thessaloniki, Greece, 56429
Netherlands
Pfizer Investigational Site, Nijmegen, Gld, Netherlands, 6525 GA
Sweden
Pfizer Investigational Site, Lund, Sweden, SE-221 85
Pfizer Investigational Site, Stockholm, Sweden, 171 76
Switzerland
Pfizer Investigational Site, St. Gallen, Switzerland, CH-9007
   A Phase II Efficacy And Safety Study Of Sunitinib Malate (SU011248) Administered In A Continuous Daily Regimen In Patients With Advanced (First-Line) Renal Cell Cancer http://clinicaltrials.gov/ct2/show/study/NCT00338884

Participants: 119 (29 f, 90 M), age <65 years—83, >65-36 participants.

Complete or partial response was observed for 41 from 116 participants (35.3%).

Median duration of overall response was 7.14 months for 41 participants.

Median time to progression was 10 months for 118 participants.

Median progression free survival was 9 months for 118 participants.

One year survival rate was 67.8% for 118 participants.

Serious adverse events were observed for 45 of 119 (37.82%) participants.

Locations:
Argentina
Pfizer Investigational Site, Rosario, Santa Fé, Argentina, (2000)
Pfizer Investigational Site, Buenos Aires, Argentina, 1431
Pfizer Investigational Site, Cordoba, Argentina, X5000AAI
Australia
Pfizer Investigational Site, Adelaide, South Australia, Australia, 5000
Pfizer Investigational Site, Clayton, Victoria, Australia, 3168
Pfizer Investigational Site, East Bentleigh, Victoria, Australia, 3165
Brazil
Pfizer Investigational Site, Porto Alegre, RS, Brazil, 90610-000
Pfizer Investigational Site, São Paulo, SP, Brazil, 01308-050
Republic of Korea
Pfizer Investigational Site, Seoul, Korea, Republic of, 120-752
Pfizer Investigational Site, Seoul, Korea, Republic of, 110-744
Mexico
Pfizer Investigational Site, Guadalajara, Jalisco, Mexico, 44280
Pfizer Investigational Site, Monterrey, Nuevo Leon, Mexico, 64460
Taiwan
Pfizer Investigational Site, Taichung, Taiwan, 407
Pfizer Investigational Site, Tainan, Taiwan, 710
Pfizer Investigational Site, Taipei, Taiwan, 112
   A Randomized Phase II Study Of The Efficacy And Safety Of Sunitinib Malate Schedule 4/2 vs. Sunitinib Malate Continuous Dosing As First-Line Therapy For Metastatic Renal Cell Cancer http://clinicaltrials.gov/ct2/show/study/NCT00267748

Participants of [symbol] Sunitinib 50 mg [symbol] group: 146 (45 f, 101 M), mean age—60 years, received 50 mg Sunitinib daily (Schedule 4/2).

Participants of [symbol] Sunitinib 37.5 mg [symbol] group: 146 (57 f, 89 M), mean age—64.3 years, received 37.5 mg Sunitinib daily.

Complete or partial response was observed for 32.2% from 146 participants of Sunitinib 50 mg group and for 28.1% from 146 participants of Sunitinib 37.5 mg group.

Median overall response duration was 12.5 months for 47 participants of Sunitinib 50 mg group and 8.7 months for 41 participants of Sunitinib 37.5 mg group.

Serious adverse events were observed for 50 from 146 (34.25%) participants of Sunitinib 50 mg group and for 54 from 143 participants (37.76%) of Sunitinib 37.5 mg group.

159 medical centers of USA participated in the study.

### 4. Pazopanib (Votrient)

Pazopanib is a multi-targeted receptor tyrosine kinase inhibitor (VEGFR-1, VEGFR-2, VEGFR-3, PDGFR-a/β in c-kit). Pazopanib is a drug FDA approved for the treatment of advanced renal cell carcinoma and soft tissue sarcoma.

The results of the following clinical trials of Pazopanib in therapy of renal cell carcinoma:

A Phase II Study of GW786034 (Pazopanib) Using a Randomised Discontinuation Design in Subjects With Locally Recurrent or Metastatic Clear-Cell Renal Cell Carcinoma http://www.clinicaltrials.gov/ct2/show/study/NCT00244764

Participants: 225 (69 f, 156 M), mean age—59.8 years.

Complete or partial response was observed for 78 participants (34.7%), stable disease—for 101 from 225 participants.

Among the first 60 participants at 12 week had 28 stable disease (47%) and 19 partial response.

Median overall response duration was 68 weeks for 78 participants (complete+partial response).

Serious adverse events were observed for 74 (32.89%) from 225 participants.

43 medical centers participated in the study.

A Randomised, Double-blind, Placebo Controlled, Multi-center Phase III Study to Evaluate the Efficacy and Safety of Pazopanib (GW786034) Compared to Placebo in Patients With Locally Advanced and/or Metastatic Renal Cell Carcinoma http://clinicaltrials.gov/ct2/show/study/NCT00334282

Participants: 435 (128 f, 307 M), mean age—59.3 years. 290 participants received Pazopanib ( [symbol] Pazopanib [symbol] ), other 145 participants received Placebo ( [symbol] Placebo [symbol] ).

Median progression free survival was 9.2 months for 290 participants of [symbol] Pazopanib [symbol] group and 4.2 months for 145 participants of [symbol] Placebo [symbol] group. The differences between groups were statistically significant.

Median overall survival was 22.9 months for 290 participants of [symbol] Pazopanib [symbol] group and 20.5 months for 145 participants of [symbol] Placebo [symbol] group.

Among the 290 participants of [symbol] Pazopanib [symbol] group had 1 complete response, 87 partial responses and 110 stable disease; among the 145 participants of [symbol] Placebo [symbol] group had 0 complete response, 5 partial response and 59 stable disease.

Median overall response duration was 58.7 weeks for 290 participants of [symbol] Pazopanib [symbol] group.

Median time to response was 11.9 weeks for 88 participants of [symbol] Pazopanib [symbol] group.

Serious adverse events were observed for 76 from 290 participants of [symbol] Pazopanib [symbol] group (26.21%) and for 28 from 145 participants of [symbol] Placebo [symbol] group (19.31%).

67 medical centers participated in the study.

A Study of Pazopanib Versus Sunitinib in the Treatment of Subjects With Locally Advanced and/or Metastatic Renal Cell Carcinoma http://clinicaltrials.gov/ct2/show/study/NCT00720941

Participants: 1110 (297 f, 813 M), mean age—61.1 years. 557 participants received 800 mg Pazopanib daily ( [symbol] Pazopanib [symbol] ), other 553 participants received 50 mg Sunitinib daily ( [symbol] Sunitinib [symbol] ).

Median progression free survival was 8.4 months for 557 participants of [symbol] Pazopanib [symbol] group and 9.5 months for 553 participants of [symbol] Sunitinib [symbol] group.

Median overall survival was 28.4 months for 557 participants of [symbol] Pazopanib [symbol] group and 29.3 months for 553 participants of [symbol] Sunitinib [symbol] group.

Among the 557 participants of [symbol] Pazopanib [symbol] group had 1 complete response, 170 partial response and 216 stable disease; among the 553 participants of [symbol] Sunitinib [symbol] group had 3 complete response, 134 partial response and 242 stable disease.

Median time to response was 11.9 weeks for 171 participants of [symbol] Pazopanib [symbol] group and 17.4 weeks for 137 participants of [symbol] Sunitinib [symbol] group.

Median duration of overall response was 13.8 months for 171 participants of [symbol] Pazopanib [symbol] group and 18 months for 137 participants of [symbol] Sunitinib [symbol] group.

Serious adverse events were observed for 230 from 554 (41.52%) participants of [symbol] Pazopanib [symbol] group and for 224 from 548 (40.88%) participants of [symbol] Sunitinib [symbol] group.

173 medical centers participated in the study.

A Study to Evaluate Efficacy and Safety of Pazopanib Versus Sunitinib for the Treatment of Asian Subjects With Locally Advanced and/or Metastatic Renal Cell Carcinoma http://clinicaltrials.gov/ct2/show/study/NCT01147822

Participants: 367 (93 f, 274 M), mean age—57.6 years. 188 participants received daily 800 mg Pazopanib ( [symbol] Pazopanib [symbol] ), other 179 participants received 50 mg Sunitinib daily ( [symbol] Sunitinib [symbol] ).

Median progression free survival was 8.4 months for 188 participants of [symbol] Pazopanib [symbol] group and 11.1 months for 179 participants of [symbol] Sunitinib [symbol] group.

Median overall survival was 31.5 months for 179 participants of [symbol] Sunitinib [symbol] group.

Among the 188 participants of [symbol] Pazopanib [symbol] group had 1 complete response, 66 partial responses; among the 179 participants of [symbol] Sunitinib [symbol] group had 0 complete response and 37 partial response.

Median time to overall response was 11.9 weeks for 67 participants of [symbol] Pazopanib [symbol] group and 17.9 weeks for 37 participants of [symbol] Sunitinib [symbol] group.

Median duration of overall response was 15.2 months for 67 participants of [symbol] Pazopanib [symbol] group and 18 months for 37 participants of [symbol] Sunitinib [symbol] group.

Serious adverse events were observed for 68 from 186 (36.56%) participants of [symbol] Pazopanib [symbol] group and for 73 from 177 (41.24%) participants of [symbol] Sunitinib [symbol] group.
Locations:
China
GSK Investigational Site, Guangzhou, Guangdong, China, 510060
GSK Investigational Site, Nanjing, Jiangsu, China, 210002
GSK Investigational Site, Hangzhou, Zhejiang, China, 310003
GSK Investigational Site, Beijing, China, 100021
GSK Investigational Site, Beijing, China, 100036
GSK Investigational Site, Beijing, China, 100853
GSK Investigational Site, Shanghai, China, 200127
GSK Investigational Site, Shanghai, China, 200032
GSK Investigational Site, Tianjin, China, 300060
Republic of Korea
GSK Investigational Site, Daejeon, Korea, Republic of, 301-721
GSK Investigational Site, Gyeonggi-do, Korea, Republic of
GSK Investigational Site, Seodaemun-gu, Seoul, Korea, Republic of, 120-752
GSK Investigational Site, Seoul, Korea, Republic of, 135-710
GSK Investigational Site, Seoul, Korea, Republic of, 138-736
Taiwan
GSK Investigational Site, Kaohsiung Hsien, Taiwan, 833
GSK Investigational Site, Taichung, Taiwan, 40705
GSK Investigational Site, Taichung, Taiwan, 40402
GSK Investigational Site, Taipei, Taiwan, 10002
GSK Investigational Site, Taipei, Taiwan, 11217
GSK Investigational Site, Taoyuan County, Taiwan, 333

### 5. Imatinib Mesylate (Gleevec)

Imatinib is a tyrosine-kinase inhibitor (abl, c-kit and PDGF-R). The drug is FDA approved for the treatment of chronic myelogenous leukemia, gastrointestinal stromal tumors (c-kit-positive), Ph-positive acute lymphoblastic leukemia.

The results of the following clinical trials of Imatinib in therapy of renal cell carcinoma:

A Phase I/II Trial of Bevacizumab (Avastin), Erlotinib (Tarceva), and Imatinib (Gleevec) in the Treatment of Patients With Advanced Renal Cell Carcinoma http://www.clinicaltrials.gov/ct2/show/study/NCT00193258

Participants: 94 (20 f, 74 M), mean age—60 years.

Complete or partial response was observed for 17% from 88 participants.

Median progression free survival was 8.9 months for 94 participants

Median overall survival was 17.2 months for 94 participants

Serious adverse events were observed for 45 from 94 participants (47.87%). This combination of drugs revealed high toxicity.

A Phase II Study of the Mammalian Target of Rapamycin (mTOR) Inhibitor RAD001 (Everolimus) in Combination With Imatinib Mesylate in Patients With Previously Treated Advanced Renal Carcinoma http://www.clinicaltrials.gov/ct2/show/NCT00331409

Participants: 19 (3 f, 16 M), mean age—65 years.

Median progression free survival at 3 month from treatments start was 2.9 months for 19 participants.

Response (complete, partial or stable disease) at 3 months was observed for 18 from 19 participants.

Median time to progression was 2.9 months for 19 participants.

Adverse events were observed for 19 participants.

Serious adverse events were observed for 10 from 19 participants (52.63%).

Medical center: OHSU Knight Cancer Institute, Portland, Oreg., United States, 97239-3098.

### 6. Dasatinib (Sprycel).

Dasatinib is an oral multi-BCR/Abl and Src family tyrosine kinase inhibitor. The drug is FDA approved for the treatment of Ph-positive chronic myelogenous leukemia and acute lymphoblastic leukemia.

Clinical trials of Dasatinib in therapy of renal cell carcinoma were not reported to the date.

### 7. Vandetanib (Caprelsa)

Vandetanib is a kinase inhibitor of a number of cell receptors, mainly the vascular endothelial growth factor receptor (VEGFR), the epidermal growth factor receptor (EGFR), and the RET-tyrosine kinase. The drug is FDA approved for the treatment of advanced medullary thyroid cancer in adult patients who are ineligible for surgery.

The following clinical trials of Vandetanib in therapy of renal cell carcinoma:

A Phase II Study of ZD6474 (Vandetanib) in Subjects With Advanced Clear Cell Renal Carcinoma http://clinicaltrials.gov/ct2/show/NCT01372813

This study has been terminated for insufficient accrual.

A Phase 2 Study of ZD6474 (Vandetanib) in Patients With Von Hippel Lindau Disease and Renal Tumors http://clinicaltrials.gov/ct2/show/NCT00566995

This study is currently recruiting participants.

### 8. Trastuzumab (Herceptin).

Trastuzumab is a monoclonal antibody that interferes with the HER2/neu receptor. The drug is FDA approved for the treatment of HER2+ breast cancer, HER+ metastatic adenocarcinoma of the stomach or gastroesophageal junction.

Clinical trials of Trastuzumab for therapy of renal cell carcinoma were not carried out to the date.

### 9. Lapatinib (Tyverb, Tykerb).

Lapatinib is a dual tyrosine kinase inhibitor which interrupts the HER2/neu and epidermal growth factor receptor (EGFR) pathways. Lapatinib ditosylate is FDA approved to treat breast cancer that is advanced or has metastasized. It is used with capecitabine in women with HER2 positive (HER2+) breast cancer whose disease has not gotten better with other chemotherapy; with letrozole in postmenopausal women with HER2+ and hormone receptor positive breast cancer who need hormone therapy.

Clinical trials of Lapatinib for therapy of renal cell carcinoma were not carried out to the date.

### 10. Flavopiridol (Alvocidib).

Flavopiridol is a cyclin-dependent kinase inhibitor (P-TEFb) under clinical development for the treatment of chronic lymphocytic leukemia.

The results of following clinical trial of Flavopiridol in therapy of renal cell carcinoma:

A Phase II Study of Flavopiridol 1 Hour Bolus Days 1-3 Q 21 Days in Patients With Advanced Renal Cell Cancer. http://clinicaltrials.gov/ct2/show/NCT00016939

This study has been completed. Its results have been published in the article: Van Veldhuizen P J, Faulkner J R, Lara P N Jr, Gumerlock P H, Goodwin J W, Dakhil S R, Gross H M, Flanigan R C, Crawford E D; Southwest Oncology Group. A phase II study of flavopiridol in patients with advanced renal cell carcinoma: results of Southwest Oncology Group Trial 0109. Cancer Chemother Pharmacol. 2005 July; 56(1):39-45. http://www.ncbi.nlm.nih.gov/pubmed/15791454?dopt=Abstract

Participants: 34 patients with unresectable or metastatic renal cell carcinoma. Among the 34 participants had 1 complete response, 3 partial response (CR+PR—for 12%) and 14 stable disease (41%). The probability of not failing treatment by 6 months was 21%. Median overall survival was 9 months. Toxicity of treatment was moderate. 101 medical centers of USA participated in the study.

Clinical Trials of Other Drugs for the Therapy of Kidney Cancer

Everolimus (Afinitor, RAD-001)

Everolimus is an inhibitor of mammalian target of rapamycin (mTOR). The drug is FDA approved for the treatment of advanced renal cell carcinoma in adults who have not gotten better with other chemotherapy (after failure of treatment with Sunitinib or Sorafenib), breast cancer, progressive neuroendocrine tumors that cannot be removed by surgery, are locally advanced, or have metastasized, subependymal giant cell astrocytoma.

The efficacy and safety of Everolimus were evaluated in an international, multicenter, randomized, double-blind trial comparing everolimus to placebo:

A Randomized, Double-blind, Placebo-controlled, Multicenter Phase III Study to Compare the Safety and Efficacy of RAD001 (Everolimus) Plus Best Supportive Care (BSC) Versus BSC Plus Placebo in Patients With Metastatic Carcinoma of the Kidney Which Has Progressed on VEGF Receptor Tyrosine Kinase Inhibitor http://www.clinicaltrials.gov/ct2/show/results/NCT00410124

Participants: 416 (94 f, 322 M), age <65 years—263, >65 years—153. 277 participants received Best Supportive Care (BSC) with Everolimus (RAD001+BSC), other 139 participants received BSC with Placebo (Placebo+BSC).

Median progression free survival was 4.9 months for 277 participants of RAD001+BSC group and 1.87 months for 139 participants of Placebo+BSC group.

Median overall survival was 13.57 months for 277 participants of RAD001+BSC group and 13.01 months for 139 participants of Placebo+BSC group.

Complete or partial response was observed for 1.8% from 277 participants of RAD001+BSC group and 0% from 139 participants of Placebo+BSC group.

Serious adverse events were observed for 135 from 274 participants (49.27%) of RAD001+BSC group, and for 60 from 111 participants (54.05%) of Placebo+BSC group.

93 medical centers participated in the study.

Temsirolimus (Torisel, CCI-779)

Temsirolimus is an inhibitor of mammalian target of rapamycin (mTOR). The drug is FDA approved for the treatment of advanced renal cell carcinoma.

The efficacy and safety of Temsirolimus were evaluated in phase 3, multicenter, international, randomized, open-label study:

A Phase 3, Three-Arm, Randomized, Open-Label Study Of Interferon Alfa Alone, CCI-779 (Temsirolimus) Alone, And The Combination Of Interferon Alfa And CCI-779 In First-Line Poor-Prognosis Subjects With Advanced Renal Cell Carcinoma http://www.clinicaltrials.gov/ct2/show/NCT00065468

Participants: 626 (194 f, 432 M), mean age—59.1 years. 207 participants received Interferon-α (first week—3 MU, second week—9 MU, following weeks—18 MU), 209 participants received Temsirolimus (25 mg once per week), 210 participants received Interferon-α+Temsirolimus (6 MU Interferona and 15 mg Temsirolimus).

Median overall survival was 7.3 months for 207 participants of Interferon-α group, 10.9 months for 209 participants of Temsirolimus group and 8.4 months for 210 participants of Interferon-α+Temsirolimus group. The differences of survival between Interferon-α and Temsirolimus groups were statistically significant.

Median progression free survival was 3.2 months for 207 participants of Interferon-α group, 5.6 months for 209 participants of Temsirolimus group and 4.9 months for 210 participants of Interferon-α+Temsirolimus group. The differences of survival between Interferon-α and other groups were statistically significant.

Complete or partial response was observed for 5.3% from 207 participants of Interferon-α group, for 9.1% from 209 participants of Temsirolimus group and for 9.5% from 210 participants of Interferon-α+Temsirolimus group.

Clinical benefit (complete, partial response or stable disease) was observed for 16.4% from 207 participants of Interferon-α group, for 34% from 209 participants of Temsirolimus group, for 30% from 210 participants of Interferon-α+Temsirolimus group. The differences of survival between Interferon-α and other groups were statistically significant.

Median overall response duration was 7.4 months for 11 participants of Interferon-α group, 11.1 months for 19 participants of Temsirolimus group, 9.3 months for 20 participants of Interferon-α+Temsirolimus group.

Median time to treatment failure was 1.9 months for 207 participants of Interferon-α group, 3.7 months for 209 participants of Temsirolimus group, 2.5 months for 210 participants of Interferon-α+Temsirolimus group. The differences of survival between Interferon-α and other groups were statistically significant. Serious adverse events were observed for 99 from 200 participants (49.5%) of Interferon-α group, for 82 from 208 participants (39.42%) of Temsirolimus group and for 122 from 208 (58.65%) participants of Interferon-α+Temsirolimus group. 154 medical centers participated in the study.

Bevacizumab (Avastin)

Bevacizumab is a humanized monoclonal antibody that produces angiogenesis inhibition by inhibiting vascular endothelial growth factor A (VEGF-A). The drug is FDA approved for the treatment of metastatic renal cell carcinoma (in combination with Interferon-a), metastatic HER2 Negative breast cancer, metastatic colorectal cancer and non-small cell lung cancer that is locally advanced, cannot be removed by surgery, has metastasized, or has recurred.

The efficacy and safety of Bevacizumab in combination with Interferon-a were evaluated in a randomized, double-blind, placebo-controlled, multinational clinical trial:

A Study of Avastin (Bevacizumab) Added to Interferon Alfa-2a (Roferon) Therapy in Patients With Metastatic Renal Cell Cancer With Nephrectomy http://www.roche-trials.com/trialDetailsGetaction?studyNumber=BO17705

Participants: 649. 327 participants received Interferon-α in combination with Bevacizumab (IF+Bv), other 322 participants received Interferon-α in combination with Placebo (IF+Placebo).

Median progression free survival was 10.2 months for participants of IF+Bv group and 5.4 months participants of IF+Placebo group

Median overall survival was same between groups.

Serious adverse events were observed for 31% participants of Interferon-α+Bevacizumab group and for 19% participants of Interferon-α+Placebo.

Axitinib (Inlyta)

Axitinib is a small molecule tyrosine kinase inhibitor (VEGFR-1, VEGFR-2, VEGFR-3, platelet derived growth factor receptor (PDGFR), and cKIT (CD117)). The drug is FDA approved for the treatment of advanced renal cell carcinoma after failure of one prior systemic therapy.

The efficacy and safety of Temsirolimus were evaluated in international randomized open-label trial:

Axitinib (AG 013736) As Second Line Therapy For Metastatic Renal Cell Cancer: Axis Trial http://clinicaltrials.gov/ct2/show/NCT00678392 This study is ongoing, but not recruiting participants.

Participants: 723 (200 f, 523 M), age <65 years—476 participants, >65-247. 361 participants received Axitinib ( [symbol] Axitinib [symbol] ), other 362 participants received Sorafenib ( [symbol] Sorafenib [symbol] ).

Median progression free survival was 6.7 months for 361 participants of [symbol] Axitinib [symbol] group and 4.7 months for 362 participants of [symbol] Sorafenib [symbol] group. The differences between groups were statistically significant.

Serious adverse events were observed for 108 from 359 (30.08%) participants of [symbol] Axitinib [symbol] group and for 110 from 355 (30.99%) participants of [symbol] Sorafenib [symbol] group. 267 medical centers participated in the study.

### CONCLUSIONS OF THE INDIVIDUAL CASE (PATIENT X)

Based on the biomaterial samples provided by the patient and/or its representative, 6 FFPE samples of malignant (tumor) tissue were analyzed. The RNA fraction was isolated from the tissue samples (paraffin-embedded tissue blocks), and then analyzed using Illumina HT12 v4 platform (USA). Expression profiles of 27000 human genes were established for each of the 6 samples analyzed.

The analysis of differentially regulated genes revealed the main intracellular signaling pathways which are differentially activated in the patients' tumor tissue compared to the set of normal tissues (6 samples of normal renal tissue taken from unrelated male healthy donors). All the analyzed patient samples showed increased values of activation index (PMS) for the following intracellular signaling pathways: ERK, p38, GSK3, AKT, cAMP, ILK, MAPK, STATS, Ras and PAK signaling. The aberrant activation of these signaling pathways may be the cause of malignant transformation of the patient tissues and might led to cancer progression.

Gene expression data for the patient cancerous tissues allowed us to analyze all existing targeted cancer therapeutics (drugs that block the growth and spread of cancer by interfering with specific molecules involved in tumor growth and progression) approved by pharmaceutical regulators in USA, Canada, EU, China and Russia. According to Drug scores data obtained using original innovative algorithm OncoFinder™ (Pathway Pharmaceuticals), several therapeutics available on the market at present can be recommended for the individual case of the patient.

According to our results, the most effective drugs for the individual patient are Sorafenib, Regorafenib, Sunitinib, Pazopanib, Imatinib, Dasatinib, Vandetanib, Trastazumab, Lapatinib, Flavopiridol (arranged in order of descending of predicted effectiveness). Completed studies include analysis of the FFPE tissue block samples of the patient cancer tissues, isolation of RNA, whole transcriptome profiling of gene expression in the biomaterial of the patient, analysis of differential gene expression, analysis of differentially regulated intracellular signaling pathways, individualized analysis of target cancer therapeutics and personalized analysis of clinical trials databases.

The references cited herein teach many principles that are applicable to the present invention. Therefore the full contents of these publications are incorporated by reference herein where appropriate for teachings of additional or alternative details, features and/or technical background.

It is to be understood that the invention is not limited in its application to the details set forth in the description contained herein or illustrated in the drawings. The invention is capable of other embodiments and of being practiced and carried out in various ways. Those skilled in the art will readily appreciate that various modifications and changes can be applied to the embodiments of the invention as hereinbefore described without departing from its scope, defined in and by the appended claims.

### REFERENCES

Bauer-Mehren, A., Furlong, L. I., Sanz, F. (2009). Pathway databases and tools for their exploitation: benefits, current limitations and challenges. Mol Syst Biol, 5, article 290. doi: 10.1038/msb.2009.47.
Birtwistle, M. R., Hatakeyama, M., Yumoto, N., Ogunnaike, B. A. et al. (2007). Ligand-dependent responses of the ErbB signaling network: experimental and modeling analyses. Mol Syst Biol, 3, article 144. doi: 10.1038/msb4100188.
Borisov, N., Aksamitiene, E., Kiyatkin, A., Legewie, S. et al. (2009). Systems-level interactions between insulin-EGF networks amplify mitogenic signaling. Mol Syst Biol, 5, article 256, 2009. doi: 10.1038/msb.2009.19.
Borisov, N. M., Chistopolsky, A. S., Faeder, J. R., Kholodenko, B. N. (2008). Domain-oriented reduction of rule-based network models. IET Syst Biol, 2, 342-351. doi: 10.1049/iet-syb:20070081.
Borisov, N. M., Markevich, N. I., Hoek, J. B., Kholodenko, B. N. (2006). Trading the micro-world of combinatorial complexity for the macro-world of protein interaction domains. BioS ystems, 83, 152-166. doi: 10.1016/j.bio systems.2005.03.006.
Borisov, Nikolay M., et al. “Signaling pathways activation profiles make better markers of cancer than expression of individual genes.” Oncotarget 5.20 (2014): 10198-10205.
Buzdin, Anton A., et al. “Oncofinder, a new method for the analysis of intracellular signaling pathway activation using transcriptomic data.” Frontiers in genetics 5 (2014).
Buzdin, Anton A., et al. “The OncoFinder algorithm for minimizing the errors introduced by the high-throughput methods of transcriptome analysis.” Frontiers in Molecular Biosciences 1 (2014): 8.
Conzelmann, H., Saez-Rodriguez, J., Sauter, T., Kholodenko, B. N., Gilles E. D. (2006). A domain-oriented approach to the reduction of combinatorial complexity in signal transduction networks. BMC Bioinformatics, 7, article 4. doi:10.1186/1471-2105-7-34.
Cooper, Geoffrey M. Sunderland (Mass.): Sinauer Associates. “Pathways of intracellular signal transduction.” (2000).
Daniels, B. C., Chen, Y. J., Sethna, J. P., Gutenkunst, R. N., Myers, C. R. (2008). Sloppiness, robustness and evolvability in systems biology. Curr Opin Biotechnol, 19, 389-395. arXiv:0805.2628v1
Elkon, R., Vesterman, R., Amit, N. (2008). SPIKE—a database, visualization and analysis tool of cellular signaling pathways. BMC Bioinformatics, 9, article 110: doi: 10.1093/nar/gkq1167.
GEO repository URL: http://www.ncbi.nlm.nih.gov/geo/
Haw, R., Stein, L. (2012). Using the Reactome database. Curr Protoc Bioinformatics, June, chapter 8, unit 8.7. doi: 10.1002/0471250953.bi0807s38.
Kholodenko, B. N., Demin, O. V., Moehren, G., Hoek, J. B. (1999). Quantification of short term signaling by the epidermal growth factor receptor. J Biol Chem, 274, 30169-30181. doi: 10.1074/jbc.274.42.30169.
Kholodenko, B., Kiyatkin, A., Bruggeman, F., Sontag, E., et al. (2003). Untangling the wires: a strategy to trace functional interactions in signaling and gene networks, Proc Natl Acad Sci, 20, 12841-12846. doi:10.1073/pnas.192442699.
Kiyatkin, A., Aksamitiene, E., Markevich N. I., Borisov, N. M. et al. (2006). Scaffolding protein GAB1 sustains epidermal growth factor-induced mitogenic and survival signaling by multiple positive feedback loops. J Biol Chem, 281, 19925-19938. doi: 10.1074/jbc.M600482200.
Korzinkin M B, Smirnov Ph. “Studies of pathological changes in mitogenetic signal pathways in cells in cancer patients using OncoFinder software package.”
Krauss, Gerhard (2008). Biochemistry of Signal Transduction and Regulation. Wiley-VCH. p. 15. ISBN 978-3527313976
Kuzmina, N. B., Borisov, N. M. Handling complex rule-based models of mitogenic cell signaling (On the example of ERK activation upon EGF stimulation). (2011). Intl Proc Chem Biol Envir Engng, 5, 76-82.
Mathivanan, S., Periaswamy, B., Gandhi, T., Kandasamy, K. et at. (2006). An evaluation of human protein-protein interaction data in the public domain. BMC Bioinformatics, 7, article S19. doi:10.1186/1471-2105-7-S5-S19.
Nakaya, A., Katayama, T., Itoh, M., Hiranuka, K. et al. (2013). KEGG OC: a large-scale automatic construction of taxonomy-based ortholog clusters. Nucleic Acids Res, January, 41. doi: 10.1093/nar/gks1239.
Nikitin, A., Egorov, S., Daraselia, N., Mazo, I. (2003). Pathway studio—the analysis and navigation of molecular networks. Bioinformatics, 19, 2155-2157. doi: 10.1093/bioinformatics/btg290.
The UniProt consortium. (2011). Ongoing and future developments at the Universal Protein Resource.Nucleic Acids Research, 39, D214-D219. doi: 10.1093/nar/gkq1020.
Yizhak K., Gabay O., Cohen H., Rupin E. (2013). Model-based identification of drug targets that revert disrupted metabolism and its application to ageing. Nature Communications, 4, 2632-doi: 10.1038/ncomms3632

1. A method for analysis of the intracellular signaling pathway activation (SPA), the method comprising:
a. analyzing activator and repressor roles of a plurality of gene products in a plurality of pathways in at least one sample of at least one healthy subject and at least one sick subject to determine a pathway activation strength (PAS) for each of said plurality of pathways; and
b. comparing said pathway activation strength (PAS) in said at least one sick subject with said at least one healthy subject to determine intracellular signaling pathway activation (SPA) associated with a disease or disorder in said at least one sick subject.

2. A method according to claim 1, wherein said method is quantitative.

3.-5. (canceled)

6. A method according to claim 1, wherein said subject is human.

7. A method according to claim 1, wherein said sick subject suffers from a proliferative disease or disorder.

8. A method according to claim 7, wherein said proliferative disease or disorder is cancer.

9. A method according to claim 1, wherein said PAS is defined by
$${PAS}_{p} = {\sum }_{n} {ARR}_{np} \cdot 1 g ( {CNR}_{n} ) .$$

10. A method according to claim 1, wherein said SPA is defined by
$${PAS}_{p}^{( 1 , 2 )} = {\sum }_{n} {ARR}_{np} \cdot {BTIF}_{n} \cdot {w}_{n}^{( 1 , 2 )} \cdot 1 g ( {CNR}_{n} ) .$$

11. A computer software product, said product configured for analysis of the intracellular signaling pathway activation (SPA), the product comprising a computer-readable medium in which program instructions are stored, which instructions, when read by a computer, cause the computer to:
a. analyze activator and repressor roles of a plurality of gene products in a plurality of pathways in at least one sample of at least one healthy subject and at least one sick subject to determine a pathway activation strength (PAS) for each of said plurality of pathways; and
b. compare said pathway activation strength (PAS) in said at least one sick subject with said at least one healthy subject to determine intracellular signaling pathway activation (SPA) associated with a disease or disorder in said at least one sick subject.

12. (canceled)

13. A bioinformatics method for ranking onco-protective drugs, the method comprising:
a. collecting healthy subject transcriptome data and sick subject transcriptome data for one species to evaluate pathway activation strength (PAS) and downregulation strength for a plurality of biological pathways;
b. mapping said plurality of biological pathways for said activation strength and downregulation strength from sick subject samples relative to healthy subject samples to form a pathway cloud map; and
c. providing a disease-protective rating for each of a plurality of drugs in accordance with a drug rating for minimizing signaling pathway cloud disturbance (SPCD) in said pathway cloud map of said one species to provide a ranking of said onco-protective drugs.

14. A method according to claim 13, wherein said pathway cloud map shows at least one upregulated/activated pathway and at least one downregulated pathway of said sick subject relative to said healthy subject.

15. A method according to claim 13, wherein said pathway cloud map is based on a plurality of healthy subjects and a plurality of sick subjects.

16.-17. (canceled)

18. A method according to claim 13, wherein said subject is a vertebrate species and said species is a human species.

19. (canceled)

20. A method according to claim 18, wherein said method is performed for an individual to determine an optimized ranking of said disease-protective drugs for said individual.

21. A method according to claim 20, wherein said disease is cancer.

22. A method according to claim 13, wherein said mapping step further comprises mapping each of said plurality of biological pathways for said activation strength and said down-regulation strength.

23. A method according to claim 22, wherein said biological pathways are signaling pathways.

24. A method according to claim 13, wherein data is obtained from studies on said samples of said subjects.

25. A method according to claim 24, wherein said samples are bodily samples selected from the group consisting of a blood sample, a urine sample, a biopsy, a hair sample, a nail sample, a breathe sample, a saliva sample and a skin sample.

26. (canceled)

27. A method according to claim 25, wherein said pathway activation strength is calculated by the formula
$${PAS}_{p} = {\sum }_{n} {ARR}_{np} \cdot 1 g ( {CNR}_{n} ) .$$

28. A method according to claim 25, wherein said SPA is defined by
PASₚ^{(1,2)}=ΣₙARRₙₚ·BTIFₙ·wₙ^{(1,2)}·lg(CNRₙ).
